(19) United States
(12) Patent Application Publication
(10) Pub. No.: US 2025/0376360 A1
(43) Pub. Date: Dec. 11, 2025

(54) WAREHOUSING SYSTEM FOR STORING AND RETRIEVING GOODS IN CONTAINERS

(71) Applicant: Symbotic LLC, Wilmington, MA (US)

(72) Inventors: Todd Kepple, Litchfield, NH (US); Zoe Dingeman, Wilmington, MA (US); Keith Crowe, Wilmington, MA (US); Kos Barsukov, Wilmington, MA (US)

(21) Appl. No.: 19/230,210

(22) Filed: Jun. 6, 2025

Related U.S. Application Data
(60) Provisional application No. 63/657,215, filed on Jun. 7, 2024.

(51) Int. Cl. B66F 9/06; B66F 9/19

(52) U.S. Cl. CPC B66F 9/063; B66F 9/195

(57) ABSTRACT

An autonomous logistics vehicle bot including a vehicle frame, a drive section operably connected to the vehicle frame to autonomously move the autonomous logistics vehicle bot within a facility and a payload bed disposed on the vehicle frame and arranged to stably hold goods payload units thereon transported with the autonomous logistics vehicle bot, where the payload bed has an index that indexes discrete payload holding sections separate and distinct from each other, and maps each indexed discrete payload holding section to corresponding different place locations within a common tote, where each respective discrete payload holding section is configured to contain at least one goods payload unit corresponding to the discrete payload holding section, and where the payload bed has a placement effector arranged so that, in the extended position, it displaces the corresponding goods payload unit from each indexed holding section and places it in the corresponding mapped location.

### CROSS REFERENCE TO RELATED APPLICATIONS

This application is a non-provisional which claims priority from and the benefit of U.S. Provisional Patent Application No. 63/657,215, filed Jun. 7, 2024, the disclosure of which is incorporated herein by reference herein its entirety.

### BACKGROUND

### 1. Field

The present disclosure generally relates to material handling systems, and more particularly, to transport and storage of items within the material handling system.

### 2. Brief Description of Related Developments

It is well recognized that integration of automated storage and retrieval systems into a logistic chain, particularly goods-to-man systems, are highly advantageous throughout efficiency and cost of the logistics chain. Conventional systems, even with a high level of automated storage and retrieval system integration in a logistic facility, operate generally by storing product (e.g., supply) containers, where the supply containers include cases, packs, etc. that contain a common type of goods (also referred to as products) in the supply containers. The product containers may arrive on pallets (e.g., of common supply containers) or as truck loads, and are either depalletized or unloaded from trucks, and stored in the logistics facility, distributed throughout the storage volume (e.g., in a three-dimensional array of storage racks) of the logistic facility by the automated storage and retrieval system.

Order fulfillment from the logistic facility, particularly in the event that mixed product containers are desired (e.g., wherein any given order container may have mixed/different products or product types held by a common container such as in cases of direct to consumer fulfillment, or if indirect to consumer, such as via a retail order pick up location, the ordered mix of products in the order container is generated, at least in part, at the logistic facility prior to output from the logistic facility) conventionally, generation of mixed product containers is effected with the automated storage and retrieval system goods to person configuration by the automated storage and retrieval system outputting the product/supply containers (each containing one or more goods items of a common good type, i.e. each goods item in the product container is the same or substantially similar) from storage locations throughout the three-dimensional array of storage racks to workstations, manual or automated, to pick and remove goods from the different product/supply containers, fed by the automated storage and retrieval system to the given workstation, pursuant to a given fulfillment (or fill) order, and to place the different picked goods (mixed or common if a given order is so filled) into order containers. Such workstations may be referred to as breakpack stations, wherein the product container is “broken” down and its contents may be placed in order containers in whole or in part, or into what may be referred to as a breakpack storage container (e.g., totes) such as where the product container is unsuitable for continued holding of remaining product items after the breakpack operation, and such remaining products (i.e., the remainder of products in the “broken” down product container) should be returned to storage in the three-dimensional array of storage racks by the automated storage and retrieval system. The products placed in the order containers are placed loosely within the container by automation such that the product packing within the order container is less than ideal. For example, conventionally the products are placed in the order containers by a conveyor belt/roller system or by a tilting/dumping system where such transfer tends to deposit the products in an area of the order containers closest to the belt/roller conveyor or tilt/dump system, failing to distribute the products evenly within or throughout the order container.

Accordingly, the present disclosure addresses any number of those issues. It would be advantageous to have a system that substantially evenly distributes product within order containers. It would be advantageous to verify distribution of products within the order containers.

### BRIEF DESCRIPTION OF THE DRAWINGS

The foregoing aspects and other features of the present disclosure are explained in the following description, taken in connection with the accompanying drawings, wherein:

FIG. 1 is a schematic illustration of an automated storage and retrieval system in accordance with the present disclosure;

FIGS. 2A and 2B are schematic illustrations of a goods bot of the automated storage and retrieval system of FIG. 1 in accordance with the present disclosure;

FIG. 2C is a schematic illustration of a portion of the goods bot of the automated storage and retrieval system of FIG. 1 in accordance with the present disclosure;

FIG. 2D is a schematic illustration of a portion of a goods bot of the automated storage and retrieval system of FIG. 1 in accordance with the present disclosure;

FIG. 3A is a schematic “cross-sectional” illustration of a portion of the goods bot of FIGS. 2A and 2B in accordance with the present disclosure;

FIG. 3B is a schematic illustration of a portion of a goods conveyor system of the goods bot of FIGS. 2A and 2B in accordance with the present disclosure;

FIGS. 3C and 3D are respectively a schematic perspective illustration of the goods bot of FIGS. 2A and 2B with an end effector in a first configuration in accordance with the present disclosure and a schematic perspective illustration of the goods bot of FIGS. 2A and 2B with the end effector in a second configuration in accordance with the present disclosure;

FIG. 3E is a schematic “cross-sectional” illustration of a portion of the goods bot of FIGS. 2A and 2B in accordance with the present disclosure;

FIG. 3F is a schematic top view of a portion of the goods bot of FIG. 3E in accordance with the present disclosure;

FIG. 3G is a schematic illustration of a portion of the goods bot of FIG. 3E in accordance with the present disclosure;

FIG. 4 is a schematic plan view illustration of an exemplary end effector drive system of the goods bot of FIGS. 2A and 2B in accordance with the present disclosure;

FIG. 4A is an exemplary schematic illustration of a payload portion of a conventional the goods bot and a goods placement in a container effected with the conventional goods bot;

FIG. 4B is an exemplary schematic illustration of a payload portion and end effector of the goods bot of FIGS. 2A and 2B and a goods placement in a container effected with the goods bot in accordance with the present disclosure;

FIGS. 5A, 5B, 5C, and 5D are exemplary schematic illustrations of a payload portion and end effector of the goods bot of FIGS. 2A and 2B and a goods placement in a container effected with the goods bot in accordance with the present disclosure;

FIG. 5E is an exemplary schematic illustration of payload transfer with a goods bot in accordance with the present disclosure;

FIGS. 6A and 6B are exemplary perspective illustrations of portions of the automated storage and retrieval system of FIG. 1 in accordance with the present disclosure;

FIG. 7 is a schematic illustration of the goods bot of FIGS. 2A and 2B interfaced with a breakpack goods container in accordance with the present disclosure; and

FIGS. 8-10 are flow diagrams of exemplary methods in accordance with the present disclosure.

### DETAILED DESCRIPTION

The following detailed description is meant to assist the understanding of one skilled in the art, and is not intended in any way to unduly limit claims connected or related to the present disclosure.

The following detailed description references various figures, where like reference numbers refer to like components and features across various figures, whether specific figures are referenced, or not.

The word “each” as used herein refers to a single object (i.e., the object) in the case of a single object or each object in the case of multiple objects. The words “a,” “an,” and “the” as used herein are inclusive of “at least one” and “one or more” so as not to limit the noun being referred to as being in its “singular” form.

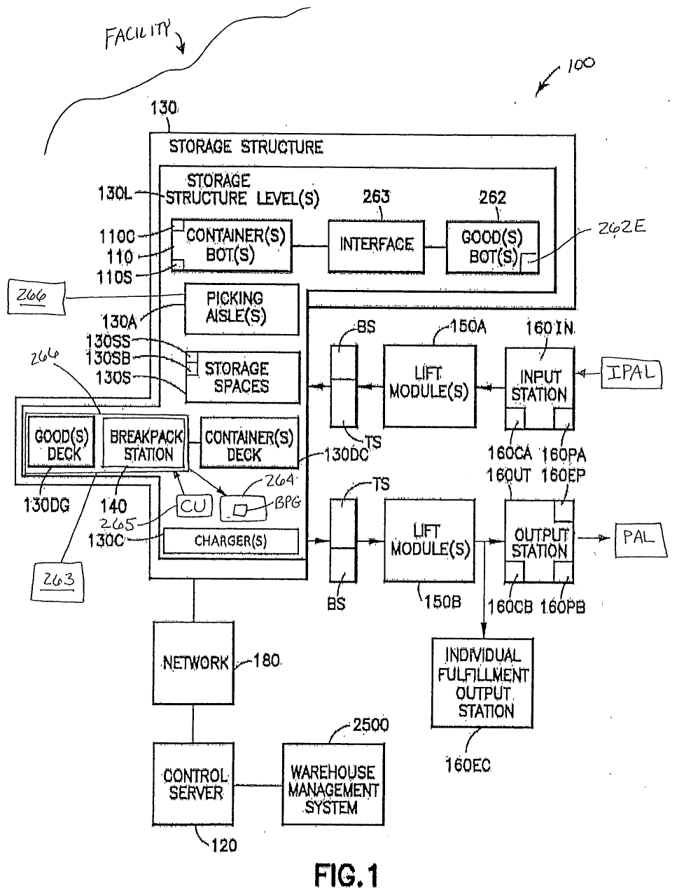

FIG. 1 is a schematic illustration of an automated or automatic (the words automated and automatic may be used interchangeably) storage and retrieval system (also referred to as a warehousing/warehouse system or product order fulfillment system) 100 in accordance with the present disclosure. Although the present disclosure will be described with reference to the drawings, it should be understood that the present disclosure can be embodied in many forms. In addition, any suitable size, shape or type of elements or materials could be used.

In accordance with the present disclosure the automatic storage and retrieval system 100 may operate in a retail distribution center or warehouse to, for example, fulfill orders received from retail stores for case units such as those described in U.S. Pat. No. 10,822,168 issued on Nov. 3, 2020, the disclosure of which is incorporated by reference herein in its entirety. For example, the case units are cases or units of goods not stored in trays, on totes or on pallets (e.g. uncontained). In other examples, the case units are cases or units of goods that are contained in any suitable manner such as in trays, on totes, in containers (such as containers of remainder goods after breakpack where the broken down case unit structure is unsuitable for transport of the remainder goods as a unit) or on pallets. In still other examples, the case units are a combination of uncontained and contained items. It is noted that the case units, for example, include cased units of goods (e.g. case of soup cans, boxes of cereal, etc.) or individual goods that are adapted to be taken off of or placed on a pallet. Shipping cases for case units (e.g. cartons, barrels, boxes, crates, jugs, or any other suitable device for holding case units) may have variable sizes and may be used to hold case units in shipping and may be configured so they are capable of being palletized for shipping. It is noted that when, for example, bundles or pallets of case units arrive at the storage and retrieval system the content of each pallet may be uniform (e.g. each pallet holds a predetermined number of the same item-one pallet holds soup and another pallet holds cereal) and as pallets leave the storage and retrieval system the pallets may contain any suitable number and combination of different case units (e.g. a mixed pallet where each mixed pallet holds different types of case units-a pallet holds a combination of soup and cereal) that are provided to, for example the palletizer in a sorted arrangement for forming the mixed pallet. The storage and retrieval system 100 described herein may be applied to any environment in which case units are stored and retrieved.

In accordance with the present disclosure, orders for filled items (e.g., the pallets, cases, containers, package of goods, individual (unpacked) goods, etc.) may be stochastic (e.g., substantially random in the items ordered and a time the order is received) and may be fulfilled by the automatic storage and retrieval system 100 as function of time (e.g., sortation of ordered goods at a predetermined scheduled time in advance of a time the order is to ship/be fulfilled or in a sortation of goods in a just-in-time manner). These stochastic orders are determinative of a pick sequence of sorted items, such as for building a pallet load or pallet PAL (see, e.g., U.S. Pat. No. 8,965,559 titled “Pallet Building System” and issued on Feb. 24, 2015, the disclosure of which is incorporated herein by reference in its entirety). The pallet PAL may include mixed cases, mixed totes, mixed packs, mixed units (or caches) per tote, etc. The sorted items are picked from a common storage array (e.g., a storage array formed by storage spaces 130S of storage structure 130). The automatic storage and retrieval system 100 effects a maximum throughput of goods for each order (e.g., received for processing by the automatic storage and retrieval system 100) by employing or otherwise processing the order through one or more of the orthogonal sortation echelons (such as described in, for example, U.S. patent application Ser. No. 17/358,383 filed on Jun. 25, 2021 and titled “Warehousing System for Storing and Retrieving Goods in Containers,” the disclosure of which is incorporated herein by reference in its entirety) to a sortation level needed (e.g., e.g., the controller 120 drills/drives down through the orthogonal sortation echelons to effect the desired level of sortation needed for a given order-a case level sortation, a pack level sortation, a unit/each level sortation or a combination thereof) to effect a given order from the common storage array independent of order type (e.g., a pallet order, a case order, a pack order, mixed orders, etc.), independent of order sequence, and independent of order time.

The automatic storage and retrieval system 100 includes one or more breakpack modules 266. Exemplary breakpack modules 266 suitable for employment with the present disclosure include those described in United States provisional patent No. 63/452,749 filed on Mar. 17, 2023 and titled “Warehousing System for Storing and Retrieving Goods in Containers” and 63/452,758 filed Mar. 17, 2023 and titled “Warehousing System for Storing and Retrieving Goods in Containers”, and those described in U.S. patent application Ser. No. 17/358,383 filed Jun. 25, 2021, Ser. No. 17/657,705 filed Apr. 1, 2022, and Ser. No. 18/323,758 filed May 25, 2023, the disclosures of which are incorporated herein by reference in their entireties. The breakpack module(s) 266 is/are configured to break down product containers or case units CU into breakpack goods containers 264 (also referred to herein as goods containers or totes for shipping goods) for order fulfillment. Product is placed into the breakpack goods containers 264 with automation (such as a goods bot or autonomous logistics vehicle bot 262 as described herein) such that the products are loosely placed. As described herein, the goods bot 262 (also referred to herein as an “autonomous logistics vehicle bot”) 262 includes a payload bed 310 for holding goods unit(s) (also referred to herein as breakpack good(s)) BPG loaded on the goods bot 262, where the payload bed 310 has or otherwise forms an end effector 262E arranged to selectively extend and unload the breakpack goods BPG from the payload bed 310. The end effector 262E (and payload bed 310) may be configured for carrying or otherwise holding multiple breakpack goods BPG in a compartmentalizing or otherwise segregating manner. The end effector 262E may substantially evenly distribute the product within the same fulfillment order in the same breakpack goods container 264.

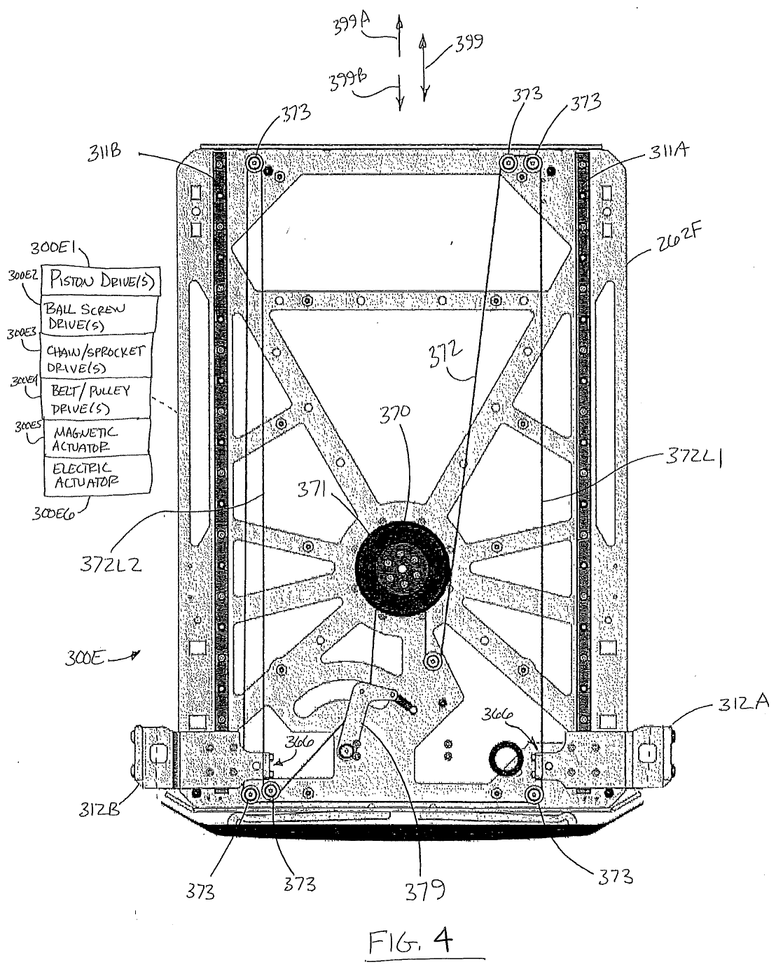

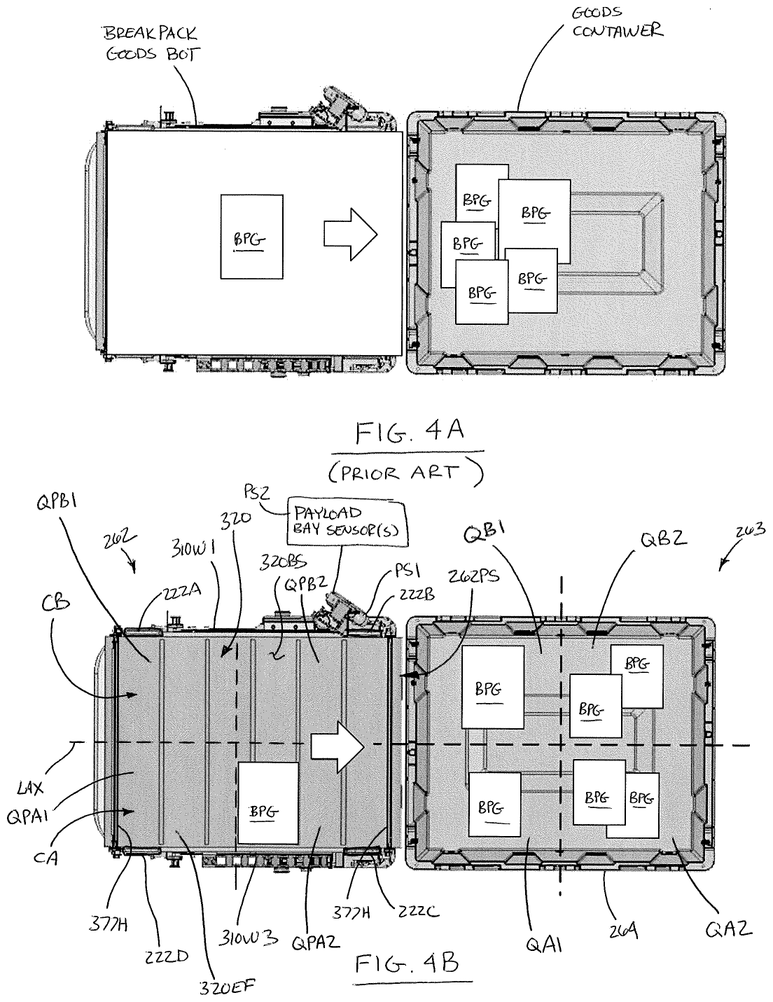

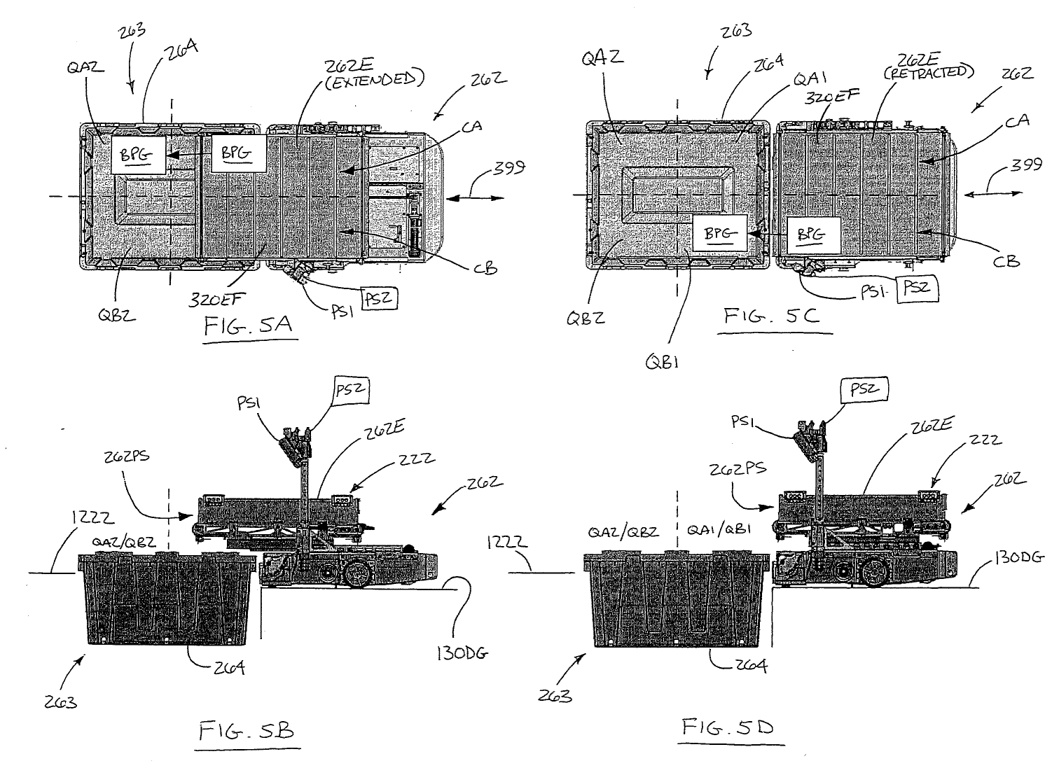

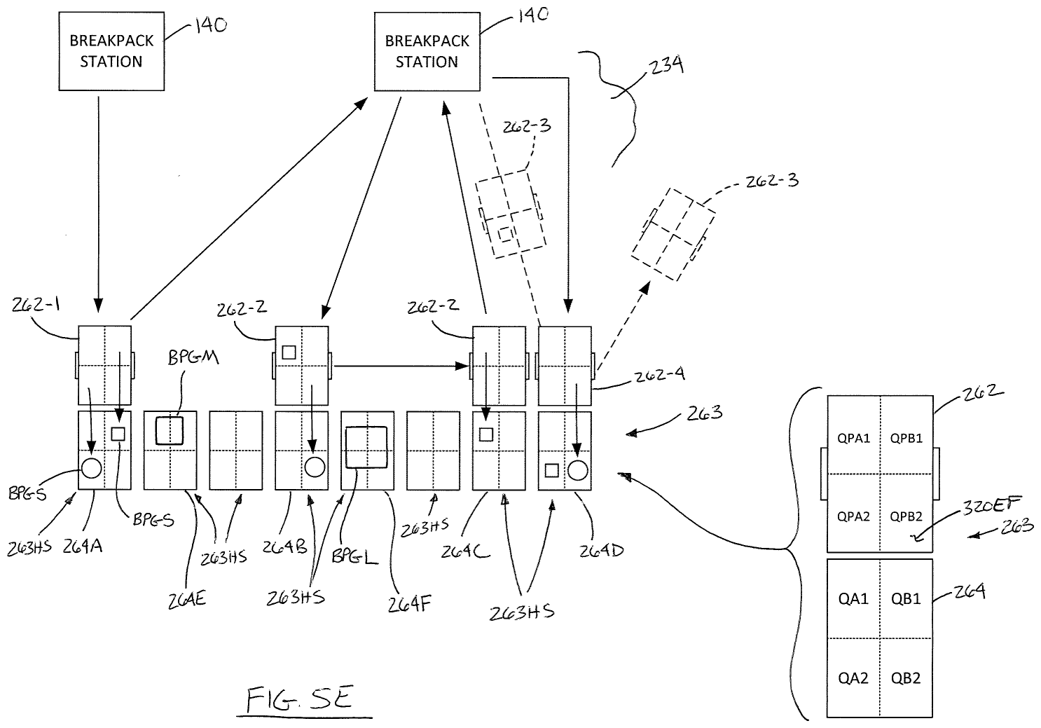

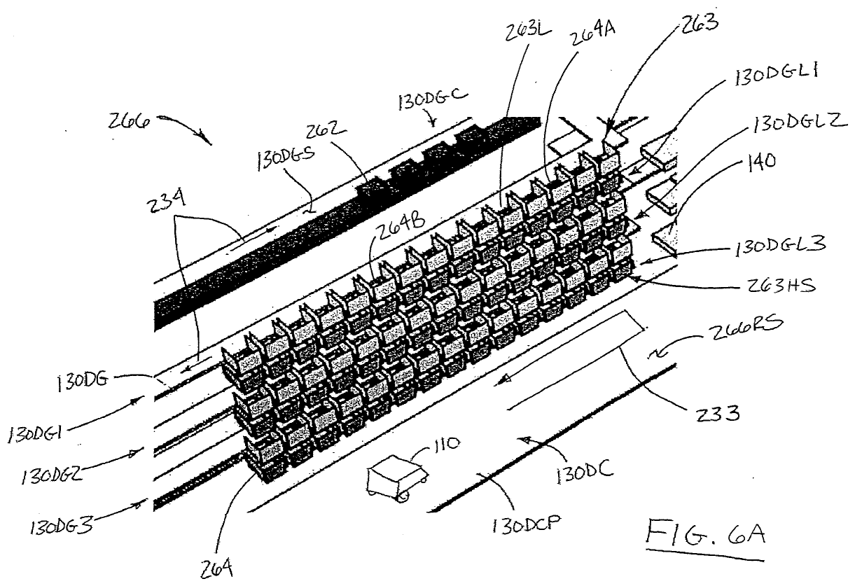

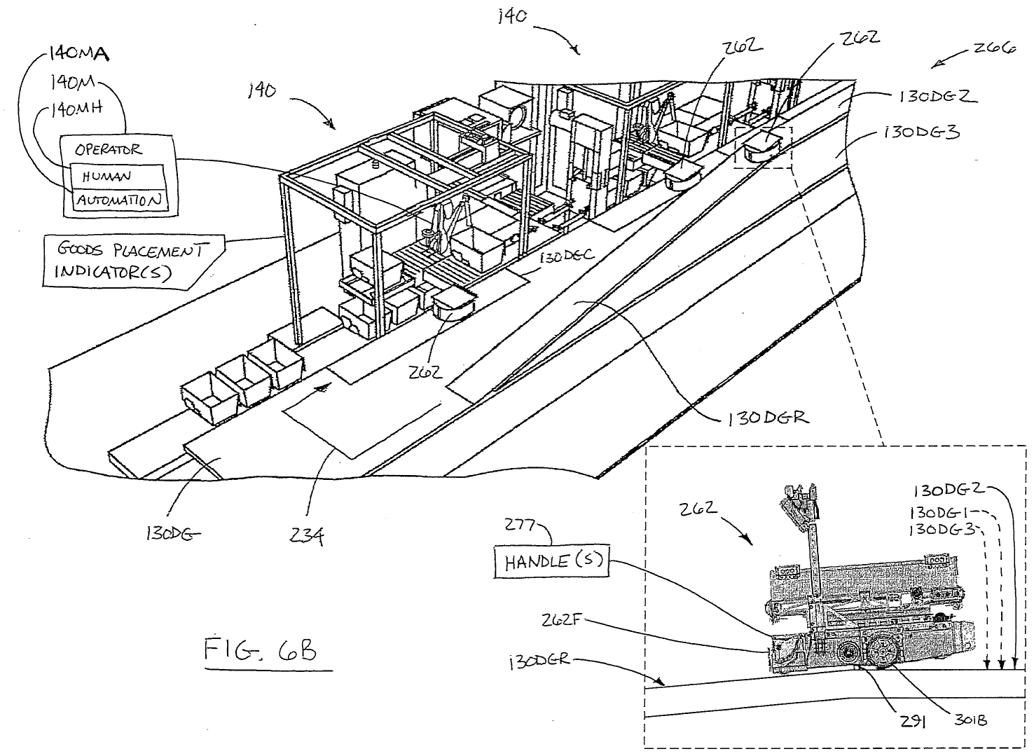

The end effector 262E is configured for variable/selective placement of breakpack goods BPG to different at least quadrants in the same breakpack goods container (or tote/shipping container) 264 so that each goods container 264 at a fill location (see, e.g., FIG. 6A) is repeatably filled, with a tote fill, substantially to a predetermined fill level 1222 (see FIGS. 5B and 5D). The predetermined fill level 1222 may be about 50% filled or greater than about 50% filled. For example, a conventional filling of a breakpack goods container is illustrated in FIG. 4A. In the conventional filling the breakpack goods are dropped/placed only on the side of the breakpack container closest to the breakpack goods bot, which results in about a 37% fill level of the breakpack goods container (with tilting of the breakpack goods container relative to the breakpack goods bot the fill level may be increased to about 45%). With reference to FIG. 4B, an in accordance with the present disclosure: an alternating placement of the breakpack goods BPG between the far (furthest from the goods bot 262—such as combined place locations QA2, QB2) and near (closest to the goods bot 262—such as combined place locations QA1, QB1) sides of the breakpack goods container 264 results in about a 55% fill level of the breakpack goods container 264; placement of the breakpack goods BPG in the breakpack goods container 264, at only the near side of the breakpack goods container 264, with alternating justification between the left and right sides (corresponding to conveyor sections CA, CB) results in about a 56% to 63% fill level of the breakpack goods container 264; and placement of the breakpack goods BPG to the breakpack goods container 264 with alternating placement into each of the place locations QA1, QA2, QB1, QB2 results in a breakpack goods container 264 fill level of about 65% to 69% or greater.

Selective placement of breakpack goods BPG in a breakpack container 264 (e.g., to the at least quadrant place locations QA1, QA2, QB1, QB2 described herein) improves the efficiency of the breakpack goods container/tote 264 fill by increasing the number of items that can be placed in a single breakpack goods container 264. More breakpack goods BPG in a breakpack goods container 264 may mean fewer breakpack goods containers 264 required to hold those breakpack goods BPG, which may save facility space and shipping/handling of the filled breakpack container 264. Fewer breakpack goods containers 264 may provide for a smaller automatic storage and retrieval system 100.

The automatic storage and retrieval system 100 may include (in addition to or in lieu of the breakpack modules 266) one or more each pick modules substantially similar to those described in U.S. Pat. No. 9,037,286 issued on May 19, 2015 (the disclosure of which is incorporated herein by reference), where the breakpack goods containers 264 are filled by human or robotic operators and output for transport by at least one autonomous container transport vehicle 110 (also referred to herein as “container bots” or “autonomous guided vehicles” and which form at least a part of an asynchronous transport system for level transport as described herein) for placement in storage or for transfer to an output station 160UT.

A controller 120 of the automatic storage and retrieval system 100 is configured to effect operation of a container bot 110 and a goods bot 262 for assembling orders of breakpack goods BPG from supply containers 265 (e.g., case units CU) into breakpack goods containers 264 and outfeed of breakpack goods containers 264 through container outfeed stations TS. For example, the controller 120 is configured to effect operation of the container bot(s) 110 between the container storage locations 130S, a breakpack operation station 140 (of a breakpack module 266), and a breakpack goods container 264 located along a breakpack goods transfer deck 130DG (see also FIGS. 6A and 6B); the controller 120 is configured to effect operation of the goods bot(s) 262 so that transport of the breakpack goods BPG, by the goods bot 262 traversing the goods transfer deck 130DG, sorts the breakpack goods BPG, e.g., in a unit/each level sortation, to corresponding breakpack goods containers 264 (see also FIG. 6A); and/or the controller 120 is configured to effect operation of the container bot(s) 110 (e.g., traversing a container transfer deck 130DC) so that the container bot(s) 110 accesses corresponding breakpack goods containers 264 at the goods transfer deck 130DG and transports the breakpack goods containers 264 via traverse along the container transfer deck 130DC to at least one of a container output/transfer station TS and a corresponding container storage location 130SB of the storage spaces 130S of a corresponding level 130L of a multilevel storage array (i.e., storage structure 130).

It is noted that when, for example, incoming bundles or pallets (also referred to as pallet loads) IPAL (e.g. from manufacturers or suppliers of case units) arrive at the storage and retrieval system 100 for replenishment of the automatic storage and retrieval system 100, the content of each pallet IPAL may be uniform (e.g. each pallet holds a predetermined number of the same item-one pallet holds soup and another pallet holds cereal). The cases of such pallet IPAL may be substantially similar or in other words, homogenous cases (e.g. similar dimensions), and may have the same SKU (otherwise, as noted before the pallets may be “rainbow” pallets having layers formed of homogeneous cases). As pallets PAL leave the storage and retrieval system 100, with cases filling customer replenishment orders, the pallets PAL may contain any suitable number and combination of different case units CU (e.g., each pallet may hold different types of case units-a pallet holds a combination of canned soup, cereal, beverage packs, cosmetics and household cleaners). The cases combined onto a single pallet may have different dimensions and/or different SKU's.

The storage and retrieval system 100 may be configured to generally include an in-feed section, a storage and sortation section (where storage of items is optional), and an output section. The storage and retrieval system 100 operating for example as a retail distribution center may serve to receive uniform pallet loads IPAL of cases, breakdown the pallet goods or disassociate the cases (e.g., at input station 160IN) from the uniform pallet loads into independent case units CU handled individually by the system 100, retrieve and sort the different cases CU sought by each order into corresponding groups, and transport and assemble the corresponding groups of cases (e.g., at the output station 160UT) into what may be referred to as mixed case pallet loads (see pallet load PAL noted above). The system 100 operating, for example, as a retail distribution center may serve to receive uniform pallet loads IPAL of cases, breakdown the pallet goods or disassociate the cases from the uniform pallet loads (e.g., at the input station 160IN) into independent case units CU handled individually by the system, retrieve and sort the different cases sought by each order into corresponding groups, and transport and sequence the corresponding groups of cases in the manner described in U.S. Pat. No. 9,856,083 issued on Jan. 2, 2018, the disclosure of which is incorporated herein by reference in its entirety.

The storage and sortation section includes a multilevel automated storage system that has an automated transport system that in turn receives or feeds individual cases CU into the multilevel storage array for storage in a storage area (such as storage spaces 130S of the storage structure 130). The storage and sortation section also defines outbound transport of case units from the multilevel storage array such that desired case units are individually retrieved in accordance with commands generated in accordance to orders entered into a warehouse management system, such as warehouse management system 2500, for transport to the output section. The storage and sortation section may receive individual cases, sort the individual cases (utilizing, for example, the buffer and interface stations described herein), e.g., in a case level sortation, and transfer the individual cases to the output section in accordance to orders entered into the warehouse management system. The sorting and grouping of cases according to order (e.g. an order out sequence) may be performed in whole or in part by either the storage and retrieval section or the output section, or both, the boundary between being one of convenience for the description and the sorting and grouping being capable of being performed any number of ways. The intended result is that the output section assembles the appropriate group of ordered cases, that may be different in SKU, dimensions, etc. into mixed case pallet loads in the manner described in, for example, U.S. Pat. No. 8,965,559 issued on Feb. 24, 2015 and titled “Pallet Building System,” the disclosure of which is incorporated herein by reference in its entirety.

In the present disclosure, the output section generates the pallet load in what may be referred to as a structured architecture of mixed case stacks. The structured architecture of the pallet load described herein is representative however, the pallet load may have any other suitable configuration. For example, the structured architecture may be any suitable predetermined configuration such as a truck bay load or other suitable container or load container envelope holding a structural load. The structured architecture of the pallet load may be characterized as having several flat case layers as described in U.S. Pat. No. 9,856,083, the disclosure of which is incorporated by reference herein in its entirety.

Still referring to FIG. 1, the automatic storage and retrieval system 100 includes a storage array (e.g., storage structure 130 having storage spaces 130S) with at least one elevated storage level 130L (where more than one elevated storage levels forms storage racks of stacked storage levels). Mixed product units are input and distributed in the storage array in cases CU of product units of common kind per case CU (each case input to the system 100 holds a common kind of stock keeping unit (SKU)). For example, the automatic storage and retrieval system 100 includes input stations 160IN (which include depalletizers 160PA and/or conveyors 160CA for transporting items (e.g., inbound supply containers) to lift modules (or lifts) 150A for entry into a storage level 130L of the storage structure 130).

The automatic storage and retrieval system 100 includes an automated or automatic transport system (e.g., bots, breakpack stations, and other suitable level transports described herein) with at least one asynchronous transport system for transporting cases/products on a given storage structure level 130L (e.g., level transport). The storage and retrieval system 100 includes undeterministic container bots 110 that travel along one or more physical pathways of the storage and retrieval system (e.g., such as one or more of the picking aisles 130A and container transfer deck 130DC) to provide at least one level of asynchronicity. The container bots 110 may be any suitable independently operable autonomous transport vehicles that carry and transfer case units along X and Y throughput axes throughout the storage and retrieval system 100. The container bots 110 may be automated, independent (e.g. free riding) autonomous transport vehicles. Suitable examples of container bots can be found in, for exemplary purposes only, U.S. Pat. No. 10,822,168 issued on Nov. 3, 2020; U.S. Pat. No. 8,425,173 issued on Apr. 23, 2013; U.S. Pat. No. 9,561,905 issued on Feb. 7, 2017; U.S. Pat. No. 8,965,619 issued on Feb. 24, 2015; U.S. Pat. No. 8,696,010 issued on Apr. 15, 2014; U.S. Pat. No. 9,187,244 issued on Nov. 17, 2015; U.S. Pat. No. 11,078,017 issued on Aug. 3, 2021; U.S. Pat. No. 9,499,338 issued on Nov. 22, 2016; U.S. Pat. No. 10,894,663 issued on Jan. 19, 2021; and U.S. Pat. No. 9,850,079 issued on Dec. 26, 2017, the disclosures of which are incorporated by reference herein in their entireties. The container bots 110 may be configured to place case units, such as the above described retail merchandise, into picking stock in the one or more levels of the storage structure 130 and then selectively retrieve ordered case units.

At least another level of asynchronicity is provided such that, for example, case/product holding locations are greater than the number of bots transporting cases/products. At least one lift module (or lift) 150B is provided for transporting cases/products between storage levels 130L (e.g., between level transport). The at least one lift 150B is communicably connected to the storage array (e.g., formed by the storage spaces 130S of the storage level(s) 130L) so as to automatically retrieve and output, from the storage array, product units distributed in the cases CU in a common part (e.g., the storage locations 130S of a respective storage level 130L) of the at least one elevated storage level 130L of the storage array. The output product units being one or more of mixed singulated product units, in mixed packed groups, and in mixed cases. As an example, the automatic storage and retrieval system 100 includes output stations 160UT, 160EC (which include palletizers 160PB, operator stations 160EP and/or conveyors 160CB for transporting items (e.g., outbound supply containers and filled breakpack goods (order) containers) from lift modules 150B for removal from storage (e.g., to a palletizer (for palletizer load) or to a truck (for truck load)). The output station 160EC may be an individual fulfillment (or e-commerce) output station where, for example, filled breakpack goods (order) containers including single goods items and/or small bunches of goods are transported for fulfilling an individual fulfillment order (such as an order placed over the Internet by a consumer). The output station 160UT may be a commercial output station where large numbers of goods are generally provided on pallets for fulfilling orders from commercial entities (e.g., commercial stores, warehouse clubs, restaurants, etc.). The automatic storage and retrieval system 100 may include both the commercial output station 16OUT and the individual fulfillment output station 160EC, although the automatic storage and retrieval system may include one or more of the commercial output station 160UT and the individual fulfillment output station 160EC.

The automatic storage and retrieval system 100 also includes the input and output vertical lift modules 150A, 150B (generally referred to as lift modules 150—it is noted that while input and output lift modules are shown, a single lift module may be used to both input and remove case units from the storage structure), a storage structure 130 (which may have at least one elevated storage level as noted above and may form a multilevel storage array), and at least one container bot 110 which may be confined to a respective storage level of the storage structure 130 and are distinct from a transfer deck 130DC on which they travel. It is noted that the depalletizers 160PA may be configured to remove case units from pallets so that the input station 160IN can transport the items to the lift modules 150 for input into the storage structure 130. The palletizers 160PB may be configured to place items removed from the storage structure 130 on pallets PAL for shipping. As used herein the lift modules 150, storage structure 130 and container bots 110 may be collectively referred to herein as the multilevel automated storage system (e.g. storage and sorting section) noted above, which has an integral “on the fly sortation” (e.g. sortation of case units during transport of the case units) so that case unit sorting and throughput occurs substantially simultaneously without dedicated sorters as described in U.S. Pat. No. 9,856,083, previously incorporated herein by reference in its entirety.

Referring to FIGS. 1 and 6A, the storage structure 130 may include a container autonomous transport travel loop(s) 233 (e.g., formed on and along a container transfer deck 130DC) disposed at a respective level of the storage structure 130. The container bots 110 travel along the container autonomous transport travel loop(s) 233 for transporting supply containers 265 to the breakpack module 266 and for retrieving breakpack goods containers 264 from the breakpack module 266 in a manner similar to that described in U.S. patent application Ser. No. 17/358,383 filed on Jun. 25, 2021 (titled “Warehousing System for Storing and Retrieving Goods in Containers”) and Ser. No. 17/657,705 filed on Apr. 1, 2022 (titled “Warehousing System for Storing and Retrieving Goods in Containers”), the disclosures of which were previously incorporated herein by reference in their entireties.

The lifts 150 may be connected via transfer stations TS (also referred to herein as container infeed stations when the lift 150 is an inbound lift 150A or as container outfeed stations when the lift 150 is an outbound lift 150B) to the container transfer deck 130DC, and each lift is configured to lift one or both of supply containers 265 (empty or filled) and the breakpack goods containers 264 (empty or filled) into and out of the at least one elevated storage level 130L of the storage structure 130. Container storage locations (or spaces) 130S are arrayed peripherally along the container transfer deck 130DC and/or picking aisles 130A such as described in U.S. Pat. No. 9,856,083, previously incorporated by reference herein in its entirety and U.S. Pat. No. 10,822,168 issued on Nov. 3, 2020, the disclosure of which is incorporated herein by reference in its entirety.

The container transfer decks 130DC are substantially open and configured for the undeterministic (i.e., not physically constrained) traversal of container bots 110 along multiple travel lanes across and along the container transfer decks 130DC. As described in U.S. Pat. No. 10,556,743 issued on Feb. 11, 2020 and having application Ser. No. 15/671,591 (the disclosure of which is incorporated herein by reference in its entirety) the multiple travel lanes may be configured to provide multiple access paths or routes to each storage location 130S (e.g., pickface, case unit, container, or other items stored on the storage shelves) so that container bots 110 may reach each storage location using, for example, a secondary path if a primary path to the storage location is obstructed. The container transfer deck(s) 130DC at each storage level 130L communicate(s) with each of the picking aisles 130A on the respective storage level 130L.

Still referring again to FIG. 1, each storage level 130L may also include charging stations 130C for charging an on-board power supply of the container bots 110 on that storage level 130L such as described in, for example, U.S. patent application Ser. No. 14/209,086 filed on Mar. 13, 2014 and U.S. Pat. No. 9,082,112 issued on Jul. 14, 2015, the disclosures of which are incorporated herein by reference in their entireties.

Referring again to FIGS. 1, 6A, and 6B, one or more of the breakpack modules 266 may be disposed in a picking aisle(s) 130A or accessed from the container transport deck 130DC such as described in U.S. patent application Ser. No. 17/358,383 filed on Jun. 25, 2021 (titled “Warehousing System for Storing and Retrieving Goods in Containers”) and Ser. No. 17/657,705 filed on Apr. 1, 2022 (titled “Warehousing System for Storing and Retrieving Goods in Containers”), the disclosures of which were previously incorporated herein by reference in their entireties.

Each of the one or more break pack modules 266 has a container bot riding surface 266RS that forms a portion 130DCP of the container transfer deck 130DC, where the riding surface 266RS is substantially similar to that of container transfer deck 130DC (e.g., open and undeterministic), although the container bot riding surface 266RS may be substantially similar to that of the picking aisles 130A (e.g., rail guided). For ease of explanation, the present disclosure will refer to the container bot riding surface 266RS within the breakpack module 266 as a portion of the container transfer deck 130DC. Where the bot riding surface 266RS is formed by a portion of (or is an extension of) the container transfer deck 130DC, the transport loop of the breakpack module 266 may be a multilane transport loop.

Each of the breakpack modules 266 includes a breakpack goods autonomous transport travel loop 234 (e.g., formed on and along a goods deck or goods transfer deck 130DG), at least one breakpack operation station 140 (configured so that one or more breakpack goods BPG are unpacked by an operator 140M (e.g., manually by a human operator 140MH or automatically with an automated operator/automation 140MA-see FIG. 6B) from supply container(s) 265 and loaded onto a goods bot 262 at the breakpack operation station 140), and a breakpack goods interface 263 disposed between and interfacing the goods transfer deck 130DG with the container transfer deck 130DC. The breakpack goods interface 263 includes holding stations 263HS (see also FIG. 5E) arrayed within the facility. The holding stations 263HS are configured to hold more than one breakpack goods container 264 so as to be filled with at least one breakpack good BPG from at least one goods bot 262.

As can be seen in FIG. 6A, the container bot travel surface 266RS of the breakpack module 266 forms a travel loop 233 around which the container bots 110 travel to respectively transport, along the container bot travel surface 266RS travel loop 233, a supply container (e.g., case unit, pickface, remainder container, etc.) between the storage locations 130S and a breakpack operation station 140 (and/or vice versa), and a breakpack goods container (also referred to as a breakpack goods container) 264 between the breakpack goods interface 263 and the breakpack goods container storage location 130SB or a lift 150B (and/or vice versa). The travel loop 233 provides the container bot 110 with random access to any and each breakpack goods interface locations 263L of the breakpack goods interface 263 along the bot travel surface 266RS, where the breakpack goods interface locations 263L form an asynchronous product distribution system.

The goods transfer deck 130DG forms a goods autonomous transport travel loop 234 disposed at the storage level 130L. The goods transfer deck 130DG is separate and distinct from the travel loop 233 formed by the container bot travel surface 266RS, and has the breakpack goods interface 263 coupling respective edges of the container autonomous transport travel loop 233 of the container transfer deck 130DC and the breakpack goods autonomous transport travel loop 234 of the goods transfer deck 130DG. The goods autonomous transport travel loop 234 formed by the goods transfer deck 130DG is disposed on a deck surface 130DGS of a deck (e.g., goods transfer deck 130DG) at a respective storage level 130L, and the breakpack goods autonomous transport travel loop(s) 234 of the goods transfer deck 130DG is disposed on a different deck surface 130DGS, separate and distinct from the deck surface of the container bot travel surface 266RS (formed by the container transfer deck 130DC and/or rails of a picking aisle 130A) where the container autonomous transport travel loop 233 is disposed. The breakpack goods autonomous transport travel loop 234 formed by the goods transfer deck 130DG (and hence the goods transfer deck 130DG) is disposed to confine at least one goods bot 262 to the respective storage level 130L.

As illustrated in FIGS. 6A and 6B, one or more of the breakpack modules 266 may include two or more (i.e., multiple levels) goods transfer decks 130DG1-130DG3 stacked one above the other where the goods transfer decks 130DG1-130DG3 are communicably connected to each other by one or more ramps 130DGR, where the ramp(s) 130DGR may form a part of the breakpack goods autonomous travel loop(s) 234; although the breakpack module(s) may have a single level where an elevated level of at least one breakpack module is connected to a container transfer deck level. The breakpack goods interface 263 may be in the form of one or more racks and include multilevel levels 130DGL1-130DGL3 that are each accessible from a common (level) container transfer deck 130DC.

The at least one goods bot 262 is arranged or otherwise configured for transporting, along the breakpack goods autonomous transport travel loop 234 formed at least by the goods transfer deck 130DG, one or more breakpack goods BPG (also referred to herein as a goods payload unit, e.g., a packed goods payload unit that is unpacked from the supply container 265 in a pack level sort or a unpacked goods payload unit (i.e., unit/each) unpacked from a packed goods payload unit in a unit/each level sort) between the breakpack operation station 140 and the breakpack goods interface 263. The unpacked and packed goods payload units have at least one of: a stable seat (i.e., a surface of the payload unit that seats on a support surface 320 of a payload bed 310 of the goods bot 262, the that is disposed to stably contact and seat on the support surface 320), and a neutrally stable (neither stable or unstable) curved or rounded seat (i.e., the curved or rounded seat is a surface of the payload unit that seats on the support surface 320 and provides a neutrally stable contact between the goods unit and the support surface 320). The container bot(s) 110 is also configured to autonomously pick and place the breakpack goods containers 264 at the breakpack goods interface 263. The breakpack goods interface 263 may be substantially similar to one or more of the transfer stations TS and buffer stations BS and include an undeterministic surface (similar to that of the rack storage spaces 130S) upon which breakpack goods containers 264 are placed so as to form an undeterministic interface between the goods transfer deck 130DG and the container transfer deck 130DC.

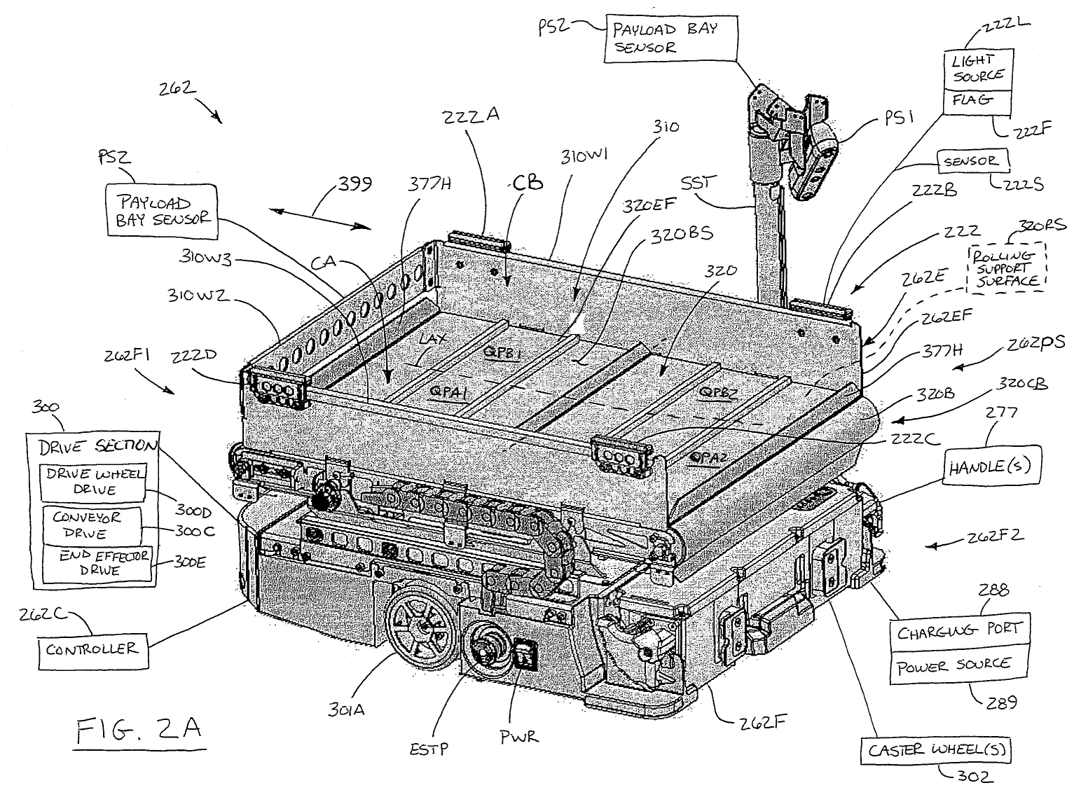

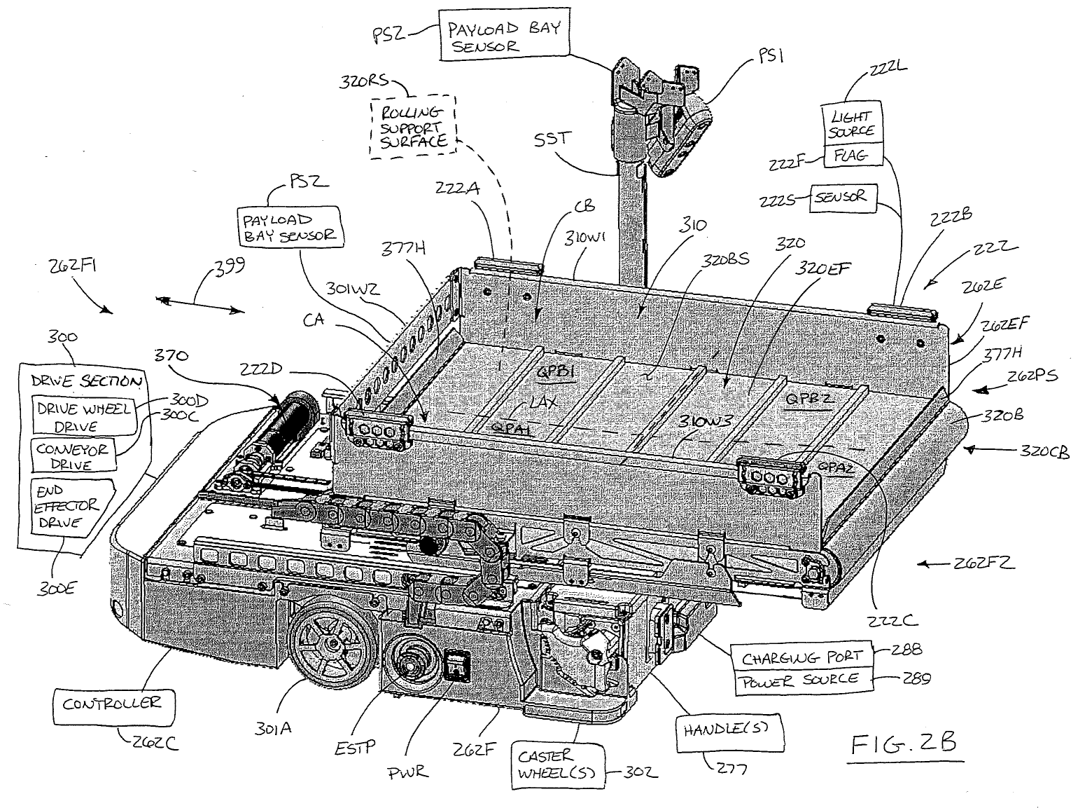

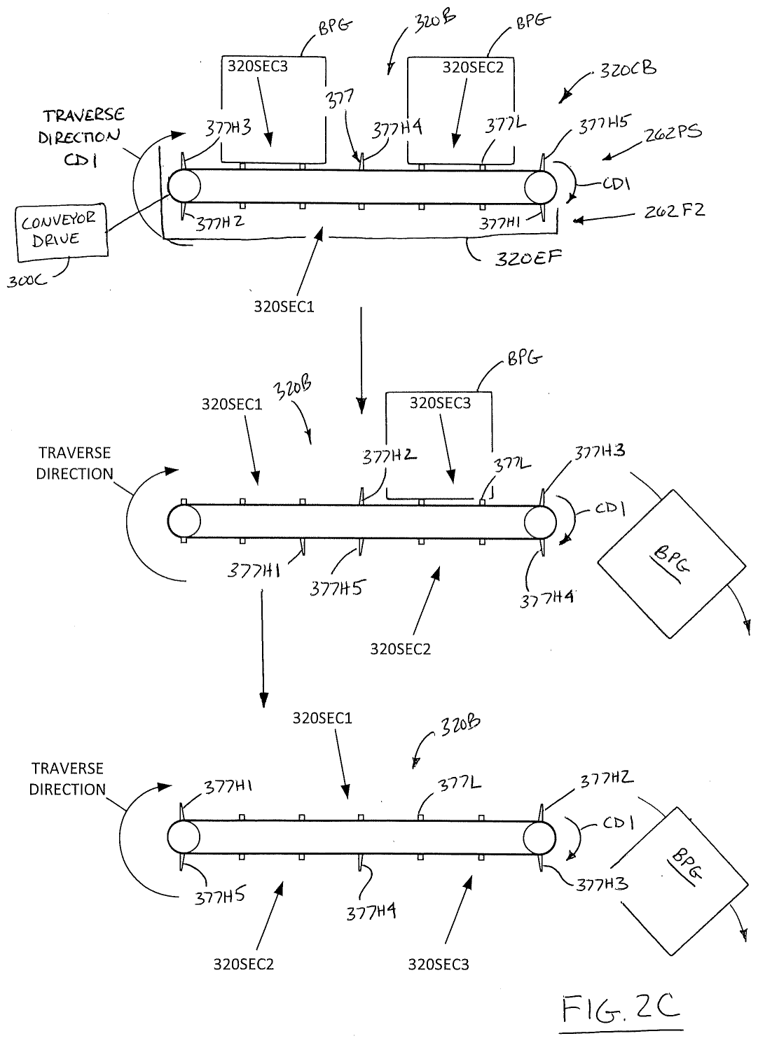

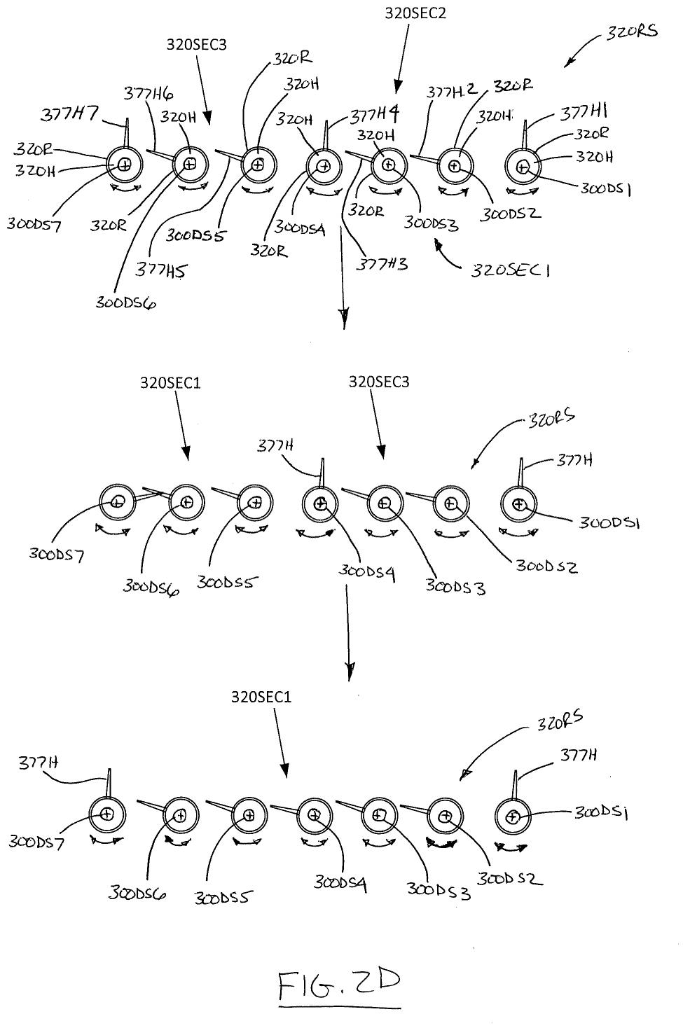

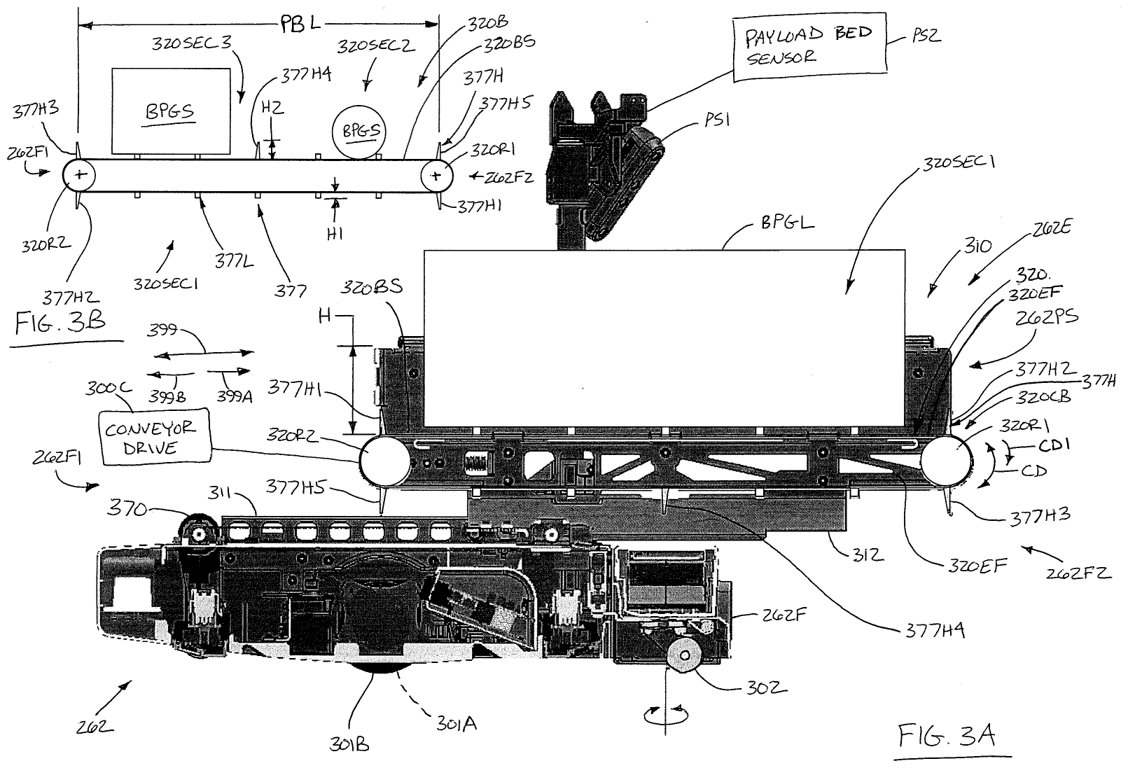

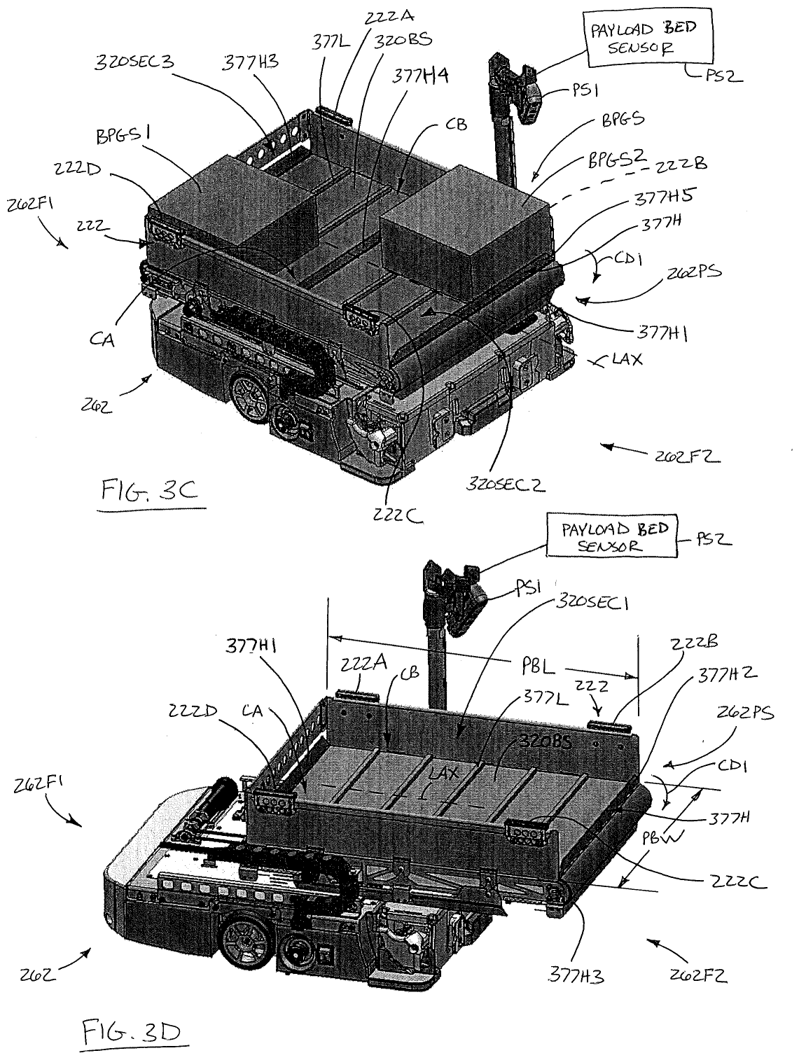

Referring to FIGS. 2A and 2B, the goods bots 262 may be any suitable type of autonomously guided bot or autonomous logistics vehicle bot with a payload configured for holding breakpack goods BPG (e.g., received from the breakpack operation station 140), not product containers (e.g., case units, pickfaces, etc.). The goods bots 262 are configured so as to automatically unload one or more breakpack goods BPG (retrieved from the breakpack operation station 140) from the goods bot 262 to breakpack goods containers 264 at the breakpack goods interface 263.

The goods bot 262 is configured as a holonomic vehicle that is capable of holonomic movement and traverse along non-holonomic paths. The goods bot 262 includes a vehicle frame 262F, a drive system or section 300, and a payload bed or bay 310. The drive section 300 is operably connected to the vehicle frame 262F to autonomously move the goods bot 262 within a facility (such as the retail distribution center or warehouse). The payload bed 310 is disposed on the vehicle frame 262F and is arranged to stably hold breakpack goods BPG thereon, where the breakpack goods BPG are transported with the goods bot 262. The payload bed 310 is movably connected to the vehicle frame 262F so that the payload bed 310 moves between extended and retracted positions (see, for example, at least FIGS. 2A and 2B) relative to the vehicle frame 262F. Movement of the payload bed 310 relative to the vehicle frame 262F, extending and retracting the payload bed 310 as a unit, commonly extends and retracts each conveyor section CA, CB (and discrete payload holding sections QPA1, QPA2, QPB1, QPB2 (described herein)) of the payload bed 310.

The payload bed 310 has an index 222 that is configured to index the discrete payload holding sections QPA1, QPA2, QPB1, QPB2 of the payload bed 310 separate and distinct from each other. The index 222 is configured to map each indexed discrete payload holding section QPA1, QPA2, QPB1, QPB2 to corresponding different place locations (such, for example, one or more of quadrants or quadrant place locations QA1, QA2, QB1, QB2 of a breakpack goods container 264 as illustrated in FIG. 4B) within a common breakpack goods container 264 (also referred to herein as a tote or shipping container, i.e., one or more goods bots may fill a common breakpack goods container) or within different breakpack goods containers 264 (i.e., a common goods bot 262 may fill a single or multiple different breakpack goods containers 264 with a common traverse of the goods bot 262 or different traverses of the goods bot 262). Where a breakpack good BPG is sized so the breakpack good BPG does not fit within at least a quadrant discrete payload holding section QPA1, QPA2, QPB1, QPB2, one or more of the discrete payload holding sections QPA1, QPA2, QPB1, QPB2 may be commonly indexed (e.g., grouped) so the larger breakpack good BPG spans or is otherwise seated within more than one adjacent discrete payload holding sections QPA1, QPA2, QPB1, QPB2.

The frame 262F is configured so that the goods bot 262 traverses, as a unit, on at least one of a transfer deck (such as the goods deck 130DG) and a ramp 130DGR (see FIGS. 6A and 6B). The frame 262F may include one or more handles 277 that effect porting (carrying transport) of the goods bot 262 by a human operator or automated handling equipment. Each handle 277 may be shaped and sized so that a human operator grips the handle 277 for lifting the goods bot 262. Where the goods bot 262 is carried by automated handling equipment, the handle 277 may include kinematic features that kinematically mate with a gripper of the automated handling equipment. Each handle 277 may be coupled to the frame 262F in any suitable manner. For example, the handle(s) 277 may be fixed to the frame with any suitable mechanical or chemical fasteners (e.g., welding, brazing, bolts, etc.); the handle(s) 277 may be removably coupled to the frame 277 so as to be attached to the frame 262F for porting the goods bot 262 and detached from the frame 262F for operation of the goods bot 262 within the storage and retrieval system 100; or the handle(s) 277 may be movably coupled to the frame with a retractable coupling 277CR so as to move from a retracted configuration (such as folded against the frame 262F such as on a hinged coupling or inserted at least partially into the frame 262F such as on a sliding coupling) to a deployed configuration (such as unfolded relative to the frame 262F such as on the hinged coupling or removed at least partially from the frame 262F such as on the sliding coupling).

The frame may also include any suitable charging ports 288 for effecting charging any suitable power source 289 onboard the goods bot 262. The charging ports may be configured as inductive ports or contact ports for coupling with any suitable charger disposed at a charging location 130DGC of the goods deck 130DG (see FIG. 6B). The charging location(s) 130DGC may be disposed at any suitable location on the goods deck 130DG such that charging of the goods bot 262 occurs during breakpack goods transfer (such as adjacent a container 264 at the interface 263 and/or at a breakpack station 140) to and/or from the goods bot 262 or at any other location of the goods deck 130DG. The frame 262F may include any suitable electrostatic grounding features 291 (see FIG. 6B) such as rods, springs, etc. Any suitable power switches PWR and emergency stop buttons ESTP may be mounted to the frame at any suitable locations for energizing and de-energizing the electronics of the goods bot 262.

A controller 262C is connected to the frame 262F and is configured (via any suitable non-transitory computer readable code including, which may include but is not limited to neural networks) to effect movement of the goods bot 262 on the at least one of the goods deck 130DG and the ramp 130DGR so that the goods bot 262 roams freely via autonomous navigation, from a first location to a different second location, wherein the first location is a supply of the goods unit (such as a breakpack station 140), and the second location is a tote fill location (such as at interface 263—see FIG. 6A) based on an order. For example, a pair of drive wheels 301A, 301B (see FIGS. 2A and 6B) are coupled to the frame 262F at any suitable location(s). In the example illustrated in the Figures, the drive wheels 301A, 301B are disposed substantially mid-way between the longitudinal ends 262F1, 262F2 of the frame 262 for effecting at least holonomic motion of the goods bot 262 along a surface on which the goods bot 262 rides; although the drive wheels 301A, 310B may be adjacent one end 262F1 of the frame 262F as described in U.S. provisional patent application No. 63/452,735 filed on Mar. 17, 2023 and titled “Warehousing System for Storing and Retrieving Goods in Containers”, the disclosure of which is incorporated herein by reference in its entirety. The drive wheels 301A, 301B are driven by a drive wheel drive 300D of the drive section 300. The drive wheel drive 300D is operated under control of any suitable controller 262C (see FIG. 2A) of the goods bot 262 to effect transfer of breakpack goods BPG in the manner described herein. The drive wheel drive 300D may be any suitable drive such as direct drive motors coupled to respective wheels 301A, 301B or any other suitable drive(s) employing any suitable transmission for imparting rotation to one or more of the wheels 301A, 301B (e.g., independent rotation of each wheel and/or differential rotation of the wheels).

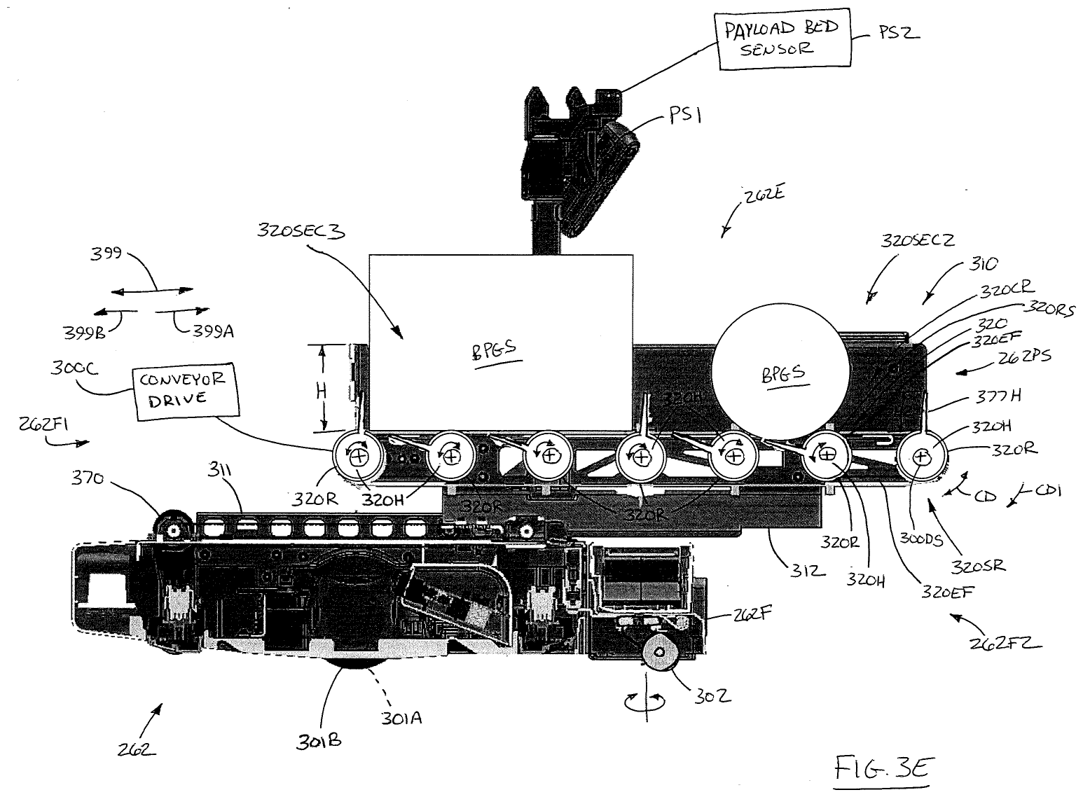

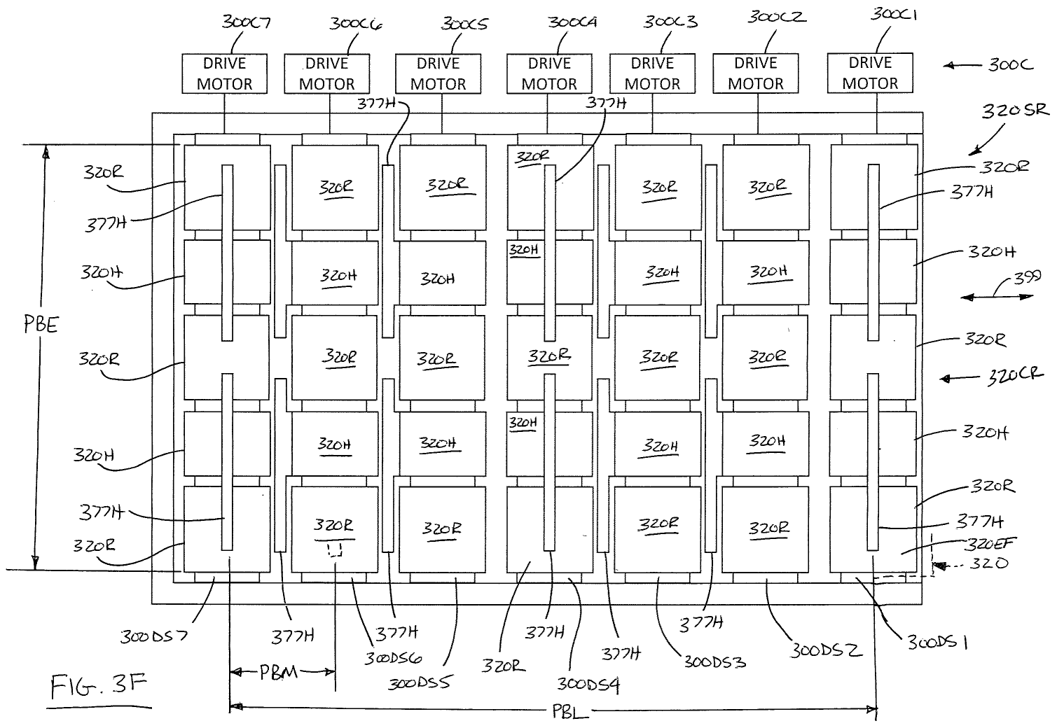

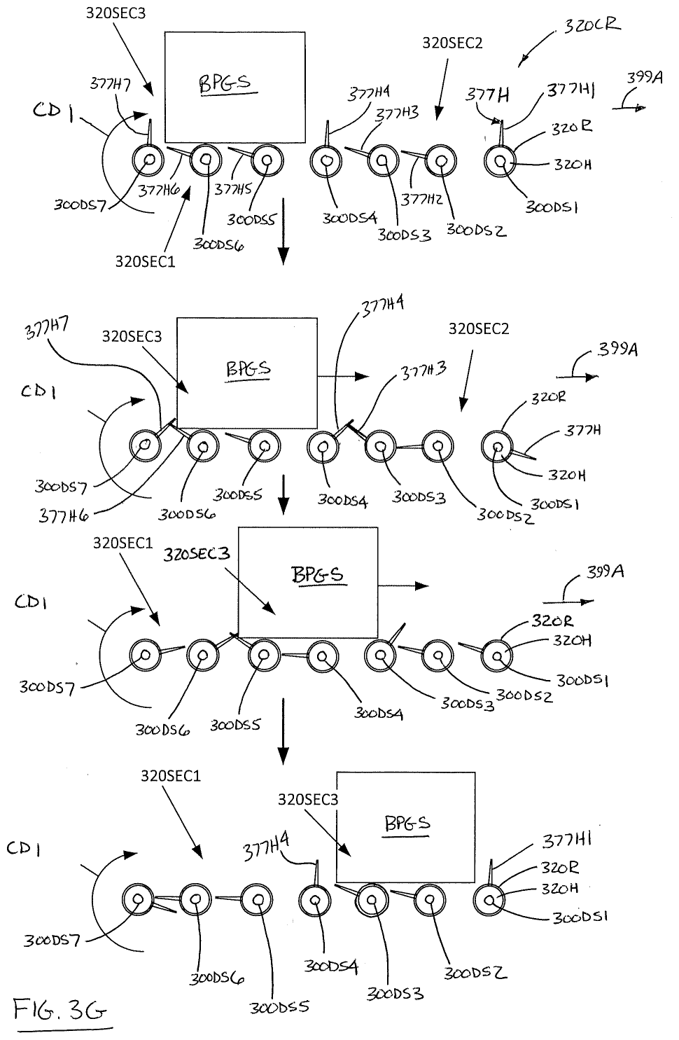

At least one caster wheel 302 (see FIGS. 2A and 3A) is coupled to the frame 262F adjacent at least one of the ends 262F1, 262F2 of the frame 262F2, although caster wheels 302 are described and illustrated the wheel(s) 302 may be steerable wheels. The drive wheels 301A, 301B and the at least one caster wheel 302 support the frame 262F for traverse of the goods bot 262 on and along the goods deck 130DG (see FIGS. 1, 6A, and 6B) and are positioned on the frame 262F so that the goods bot 262 remains stable (e.g., does not tip laterally or longitudinally and/or all wheels of the goods bot 262 remain in contact with a riding surface (such as of the goods deck 130DG) on which the goods bot 262 traverses) for receiving breakpack goods BPG to the payload bed 310, dispensing breakpack goods BPG from the payload bed 310, and traversal of the goods deck 130DGG. The goods bot 262 may include any suitable covers for covering one or more components of the goods bot 262.

The goods bot 262 includes any suitable feedback devices (such as a vision system) connected to the controller 262C. The feedback devices include at least one sensor PS1, PS2 that effect(s), with the controller 262C, one or more of goods bot localization/navigation within the breakpack module 266 and object detection. The at least one sensor PS1, PS2 is/are inclusive of, but is/are not limited to, any suitable camera(s). The object detection may be one or more of detection of objects on the goods deck 130DC (e.g., detection of other goods bots and/or debris, etc.), detection of objects at the interface 163 (e.g., goods containers, breakpack goods BPG within a goods container 264, etc.), detection of objects within the payload bed 310 of the goods bot 262 (e.g., breakpack goods within the payload bed 310, etc.), or any other suitable object on-board or off-board the goods bot 262. The at least one sensor PS1, PS2 is connected to the frame 262F and operably connected to the controller 262C, wherein the at least one sensor includes a (e.g., at least one) payload sensor PS2 arranged so as to image the payload (e.g., the payload including one or more breakpack goods BPG) carried in the payload bed 310, and wherein the controller 262C is configured so as to register the image of the payload, from the at least one sensor PS2, and from the image detect presence of the breakpack goods BPG, or identify the breakpack goods BPG, in the payload. The controller 262C is configured to determine, based on the detected presence or identity, conformance of the payload with a predetermined load condition based on the order, and initialize a different transport command based on determination of conformance (e.g., correct goods for the order, goods properly discharged from the payload bed 310, etc.) or non-conformance (e.g., incorrect goods for the order, goods not properly discharged from the payload bed 310, etc.). The controller 262C may be configured to send a communication signal to an operator or management system (inclusive of controller 120), representative or corresponding to determination of conformance or non-conformance. Where non-conformance is detected the controller 262C may effect a visual and/or aural request/instruction for rectification (e.g., at a breakpack station 140 or other area) where the breakpack goods BPG are not properly discharged from the payload bed 310 or not properly placed (as described herein) within the payload bed 310. At least one navigation sensor PS1 is also provided for one or more of effecting navigation of the goods bot 262 and verifying placement of breakpack goods BPG in a goods container 264. Suitable examples of goods bot sensors (vision system) and their operation are described in United States provisional patent application No. 63/452,735 filed on Mar. 17, 2023, the disclosure of which was previously incorporated herein by reference in its entirety.

The payload bed 310 is connected to the frame 262F for holding the breakpack goods BPG loaded on the goods bot 262. The payload bed 310 has a placement effector 320EF arranged so that with the payload bed 310 in an extended position (e.g., the extended position being a forward-most position, towards end 262F2, relative to the vehicle frame 262F as illustrated in FIG. 2B), the placement effector 320EF displaces at least one breakpack goods BPG from each (or at least one) indexed respective discrete payload holding section QPA1, QPA2, QPB1, QPB2, and places the corresponding at least one breakpack goods BPG in the corresponding place location (e.g., such as one or more of, for example, quadrants QA1, QA2, QB1, QB2) mapped by the index 222. The payload bed 310 has a support surface 320 that is disposed to contact and support each of the breakpack goods BPG in the payload bed 310. The support surface 320 is arranged to traverse within the payload bed 310 (as described herein) and form the placement effector 320EF, where the traverse of the support surface 320 displaces the at least one breakpack goods BPG corresponding to each (or at least one) discrete payload holding section QPA1, QPA2, QPB1, QPB2 and places the at least one breakpack goods BPG into the corresponding place location QA1, QA2, QB1, QB2 according to the index 222. Traverse of the support surface 320 is separate and distinct from the payload bed 310 movement.

The payload bed 310 may have more than one discrete payload holding sections QPA1, QPA2, QPB1, QPB2 (as described herein) disposed therein separate and distinct from each other. Each of the discrete payload holding sections QPA1, QPA2, QPB1, QPB2 may be delimited (physically and/or virtually), at least in part, by lateral conveyor sections 320SEC1-320SEC3 and longitudinal conveyor sections CA, CB and is configured to contain therein at least one breakpack good BPG separate and distinct from each other breakpack goods BPG seated on the support surface 320 of the payload bed 310. At least one of the lateral conveyor sections 320SEC1-320SEC3 may have a different seat size than another of the lateral conveyor sections 320SEC1-320SEC3, so that the at least one discrete payload holding sections QPA1, QPA2, QPB1, QPB2 delimited by, for example lateral conveyor section 320SEC1, accepts and stably holds a goods payload unit (see for example, breakpack goods BPGL) having a size unacceptable to the other discrete payload holding sections (see for example discrete payload holding sections delimited by lateral conveyor sections 320SEC2, 320SEC3).

The payload bed 310 has or otherwise forms an end effector 262E arranged to extend (e.g., in direction 399) and unload the breakpack goods BPG from the payload bed 310. The payload bed 310 includes a support surface 320, where the payload bed 310 (forming the end effector 262E) includes an end effector frame 262EF and the support surface 320. The support surface 320 is coupled to the end effector frame 262EF (which is moveably connected to the vehicle frame 262F) in any suitable manner so as to traverse or otherwise move relative to the vehicle frame 262F.

Traverse of the support surface 320, so that the support surface 320 commonly traverses as a unit, relative to the payload bed 310 one or more of: commonly repositions each lateral conveyor section 320SEC1-320SEC3 (and the discrete payload holding sections QPA1, QPA2, QPB1, QPB2 thereof) in the payload bed 310 from a first position (see FIGS. 2C and 2D), and swaps with a common movement of the support surface 320, at least one lateral conveyor section 320SEC1-320SEC3 (and the discrete payload holding sections QPA1, QPA2, QPB1, QPB2 thereof) in the payload bed 310 with another different lateral conveyor section 320SEC1-320SEC3 (see FIGS. 2C and 2D). The swap moves the at least one lateral conveyor section 320SEC1-320SEC3, from an inaccessible position (see, e.g., lateral conveyor section 320SEC1 at the top of FIGS. 2C and 2D) in the payload bed 310 to an accessible position (see, e.g., lateral conveyor section 320SEC1 at the bottom of FIGS. 2C and 2D) in the payload bed 310 (noting that lateral conveyor section 320SEC1 moving from the inaccessible position to accessible position is exemplary only and that holding section 320SEC2, 320SEC3 may be moved from the inaccessible position to the accessible position in the same manner).

The support surface 320 is common to each of the longitudinal conveyor sections CA, CB and each of the lateral conveyor sections 320SEC1-320SEC3 so as to define a common seat (onto which breakpack goods BPG are seated) for each of the discrete payload holding sections QPA1, QPA2, QPB1, QPB2. The support surface 320 may be formed by an endless/continuous belt or conveyor surface 320BS of an endless or continuous belt 320CB connected to the end effector frame 262EF or a rolling support surface 320RS formed by a series of rollers 320SR (i.e., a roller conveyor 320CR) connected to the end effector frame 262EF.

For example, referring also to FIGS. 3A and 3B, the support surface 320 is in the form of an endless/continuous belt conveyor 320B that spans between two rollers 320R1, 320R2, at least one of which rollers 320R1, 320R2 is a drive roller that effects movement of the support surface 320 in direction CD (see FIG. 3A) about the rollers 320R1, 320R2. The rollers 320R1, 320R2 are connected to the end effector frame 262EF so as to rotate about their respective longitudinal (lengthwise) axes where at least one roller 320R1, 320R2 is driven by any suitable conveyor drive 300C (e.g., rotary drive, worm drive, gear drive, belt and pulley drive, etc., each having a suitable motor) of the drive section 300. A tension of the support surface 320 between the rollers 320R1, 320R1 or a configuration of the support surface 320 may be such as to support or otherwise uphold a weight of the breakpack goods BPG held on the support surface 320 substantially without deflection of the support surface 320 between the rollers; although any suitable number of rollers (driven or idler) or any other suitable support members (e.g., plates, etc.) may be provided between the roller 320R1, 320R2 so as to at least in part uphold the weight of any breakpack goods BPG held the support surface 320 (e.g., between the rollers 320R1, 320R2). While support surface 320 is described as being in the form of an endless belt conveyor 320B, the support surface 320 may be and/or the end effector 262E may include any suitable conveyance that carries, pushes or otherwise moves breakpack goods from the payload bed 310.

The payload bed 310 (and end effector 262E formed thereby) has at least one side wall 310W1-310W3 containing the payload (e.g., one or more breakpack goods BPG) held by the goods bot 262. The at least one side wall 310W1-310W3 form(s) a perimeter wall(s) of the payload bed 310 that extend(s) away from the support surface 320 any suitable distance or height H (FIG. 3A) so as to substantially contain the breakpack goods BPG within the payload bed 310. As illustrated in at least FIG. 2A, the payload bed 310 has an open side 262PS (i.e., the open side lacks a fixed perimeter wall) at or adjacent one longitudinal end 262F1, 262F2 of the frame (the open side 262PS is illustrated at or adjacent longitudinal end 262F2 for exemplary purposes only).

The payload bed 310 has at least one sectioning wall, tab or protrusion 377 (referred to as protrusions for ease of description) forming a demarking or boundary discriminating at least one of the discrete payload holding sections QPA1, QPA2, QPB1, QPB2 from another discrete payload holding section QPA1, QPA2, QPB1, QPB2 in accordance with the index 222.

The support surface 320, in the form of the endless/continuous belt conveyor 320B, is configured to retain breakpack goods BPG within the payload bed 310 so as to substantially prevent uncommanded (e.g., undesired) egress of breakpack goods BPG from the payload bed 310 through the open side 262PS. For example, referring to FIGS. 2A, 2B, and 3A-3D, the endless/continuous belt 320CB of the endless/continuous belt conveyor 320B includes one or more protrusions 377 that extend transverse to the extension/retraction direction 399 of the end effector 262E where the one or more protrusions 377 at least in part engage breakpack goods BPG (e.g., in a manner similar to that of side wall 310W2) and substantially retain the breakpack goods BPG within the payload bed 310. The one or more protrusions 377 may extend any suitable distance H1, H2 from the support surface 320 for engaging and retaining one or more breakpack goods BPG. The one or more protrusions 377 having different heights H1, H2 may effect one or more of substantially preventing breakpack goods BPG (such as bottles or other cylindrical, spherical, etc. shaped items) from rolling or otherwise moving within the payload bed 310 (i.e., relative to the payload bed 310) with the goods bot 262 traversing the goods transfer deck 130DG and pushing the breakpack goods from the payload bed 310 into a goods container 264.

The protrusions 377L (which may form a part of or may be coupled to the support surface 320) having the height H1 are sized so as to at least substantially prevent breakpack goods BPG (such as bottles or other cylindrical, spherical, etc. shaped items) from rolling or otherwise moving within the payload bed 310 (i.e., relative to the payload bed 310) with the goods bot 262 traversing the goods transfer deck 130DG.

The protrusions 377H having the height H2 are sized so as to substantially prevent uncommanded (e.g., undesired) egress (e.g., falling out) of breakpack goods BPG from the payload area by forming at least one movable perimeter wall (e.g., at or adjacent the opening 262PS) of the payload bed 310. Forming a movable perimeter wall at the open side 262PS provides for higher goods bot 262 travel speeds than would otherwise be allowed with an unblocked open side 262PS.

The protrusions 377H having the height H2 may be sized so as to one or more of compartmentalize the support surface 320 into lateral conveyor sections 320SEC1-320SEC3, where each lateral conveyor section 320SEC1-320SEC3 segregates (according to a respective predetermined fulfillment order and/or respective predetermined destination breakpack goods container 264) at least one breakpack good BPG from other breakpack goods BPG held in other lateral conveyor sections 320SEC1-320SEC3 of the support surface 320 in the manner described in U.S. provisional patent application Ser. No. ______, filed on ______. (titled “Warehousing System For Storing And Retrieving Goods In Containers”), the disclosure of which is incorporated herein by reference in its entirety. The longitudinal conveyor sections CA, CB and/or the lateral conveyor sections 320SEC1-320SEC3 may effect segregating breakpack goods for different fulfillment orders in different breakpack goods containers 264 or effect placement of the breakpack goods BPG held by the different compartments in a common (i.e., the same) breakpack goods container 264 where the breakpack goods belong to the same fulfillment order.

As illustrated in at least FIGS. 3A-3D the support surface 320, in the form of the endless/continuous belt conveyor 320CB, is compartmentalized/sectionalized by the protrusions 377H into three lateral conveyor sections 320SEC1-320SEC3 (while three lateral conveyor sections are illustrated there may be more or less than three lateral conveyor sections so as to effect, at least in part, more or less than four (quadrant) discrete payload holding sections). For exemplary purposes, holding section 320SEC1 is formed between protrusions 377H1, 377H2 and spans substantially the entire length PBL of the support surface 320 surface between the rollers 320R1, 320R2 and is sized to receive larger breakpack goods (e.g., breakpack goods having one or more of a length, width, and height that is greater than one-half of the length PBL (but less than or equal to the length PBL) of the support surface 320, where the length, width, and height of the larger breakpack goods are sized so that at least two of the length, width, and height fit within the bounds of the compartment formed by the space between the protrusions 377H and the width PBW of the support surface 320). While holding section 320SEC1 is described as holding larger breakpack goods BPG, it should be understood that holding section 320SEC1 may be employed for holding any suitably sized breakpack good (and/or any number of suitably sized breakpack goods) that fits within the bounds of holding section 320SEC1.

The lateral conveyor sections 320SEC2, 320SEC3 are disposed adjacent one another where the bounds of lateral conveyor section 320SEC2 are defined by the width PBE of the support surface and the distance between adjacent protrusions 377H3, 377H4, while the bounds of lateral conveyor section 320SEC3 are defined by the width PBE of the support surface and the distance between adjacent protrusions 377H4, 377H5. The lateral conveyor sections 320SEC2, 320SEC3 are sized to form respective compartments that each span about half the length PBL of the support surface 320 surface between the rollers 320R1, 320R2 (although the lateral conveyor sections 320SEC2, 320SEC3 may have any suitable size less than the length PBL for holding a respective at least one breakpack good). The lateral conveyor sections 320SEC2, 320SEC3 are configured to hold smaller breakpack goods BPGS (compared to the larger breakpack goods BPGL described above, which have a length, width, and/or height that does not fit within the bounds of lateral conveyor sections 320SEC2, 320SEC3) such as any suitable breakpack goods that fit within the bounds of the lateral conveyor sections 320SEC2, 320SEC3. As illustrated in FIGS. 3E and 3F the support surface 320, in the form of a series or array of rollers 320SR is compartmentalized/sectionalized by the protrusions 377H into three lateral conveyor sections 320SEC1-320SEC3 (while three lateral conveyor sections are illustrated there may be more or less than three lateral conveyor sections).

The protrusions 377H may extend from respective hubs 320H where each hub has at least one protrusion 377H extending therefrom. The hubs 320H are coupled to respective drive shafts 320DS1-320DS7 so as to rotate as a unit with the respective drive shafts 320DS. In FIGS. 3E and 3F there are seven drive shafts 320DS1-320DS7 illustrated, although there may be more or less than seven drive shafts. Each drive shaft 320DS1-320DS7 is illustrated as having two hubs 320H (and the respective protrusions 377H) coupled thereto, although there may be more or less than two hubs 320H on each drive shaft 320DS1-320DS7. Each drive shaft 320DS1-320DS7 is driven by a respective drive motor 320C1-320C7 of the conveyor drive 300C.

The series or array of rollers 320SR includes rollers 320R that are mounted on each drive shaft 320DS by any suitable bearing so that rotation of the rollers 320R is not coupled to the rotation of the drive shaft 320DS to which a roller is mounted (i.e., the rollers 320R rotate independently of or freely rotate relative to the drive shaft to which they are mounted). The rollers 320R may have a diameter that is greater than the diameter of the hubs 320H so that breakpack goods BPG may roll on the rollers 320R within the payload bed 310 (confined by the protrusions 377H) without touching the hubs 320H, although the rollers 320R and hubs 320H may have substantially the same diameters so that the breakpack goods BPG roll on the rollers 320R but slide over or are driven in motion by the hubs 320H.

The series or array of rollers 320SR and hubs 320H (with the respective protrusions 377H) are configured to retain breakpack goods BPG within the payload bed 310 so as to substantially prevent uncommanded (e.g., undesired) egress of breakpack goods BPG from the payload bed 310 through the open side 262PS in the same manner described above with respect to the endless/continuous belt conveyor 320B, where the protrusions 377H compartmentalizes the payload bed 310 into the more than one lateral conveyor sections 320SEC1-320SEC3. For example, the rollers 320R mounted to each drive shaft 320DS1-320DS7 are spaced within the payload bed 310 across the width of the payload bed 310. The rollers 320R extend transverse to the extension/retraction direction 399 of the payload bed 310 where the rollers 320R at least in part engage breakpack goods BPG (e.g., the breakpack goods BPGS in the form of cylinders or tubes may sit in a trough between adjacent rollers 320R akin to sitting between the protrusions 377L of the endless/continuous belt 320CB, or the breakpack goods BPGS, BPGL in the form of a cuboid or box sit on adjacent rollers 320R) where the protrusions 377H (defining a respective lateral conveyor section 320SEC1-320SEC3) substantially retains the breakpack goods BPG within the payload bed 310. The protrusions 377H may extend any suitable distance H2 from the rolling support surface 320RS (forming the support surface 320) of the rollers 320R for engaging and retaining breakpack goods BPG. The protrusions 377H may effect one or more of substantially preventing breakpack goods BPG (such as bottles or other cylindrical, spherical, etc. shaped items) from rolling or otherwise moving (uncommanded) out of the payload bed 310 or between lateral conveyor sections 320SEC1-320SEC3 with the goods bot 262 traversing the goods transfer deck 130DG and pushing the breakpack goods from the payload bed 310 into a goods container 264. The recesses or troughs between the rollers 320R may effect substantially preventing breakpack goods (such as bottles or other cylindrical, spherical, etc. shaped items) from rolling or otherwise moving within the payload bed 310 (i.e., relative to the payload bed 310) with the goods bot 262 traversing the goods transfer deck 130DG.

For exemplary purposes, referring to FIGS. 3D, 3E, 3F, and 3G, lateral conveyor sections 320SEC1-320SEC3 are dynamically formed by the protrusions 377H coupled to the respective drive shafts 320DS. For example, the drive motors 320C1-320C7 are operated, such as by the controller 262C (see FIG. 2A), so that the drive shafts 320DS1, 320D7 are rotated and predetermined ones of the protrusions 377H1-377H7 present themselves within the payload bed 310 to partition or compartmentalize the payload bed 310. For example, referring to FIG. 3D, protrusions 377H1, 377H4, 377H7 are presented in the payload bed 310 forming lateral conveyor sections 320SEC2, 320SEC3 for seating breakpack goods therein/thereon. The drive motors 320C1-320C7 are operated, such as by the controller 262C (see FIG. 2A), to rotate the drive shafts 320DS1-320DS7 and to sequentially present the protrusions 377H1-377H7 so that the lateral conveyor sections 320SEC2, 320SEC3 are dynamically formed in a manner that traverses the lateral conveyor sections 320SEC2, 320SEC3 (and the discrete payload holding sections QPA1, QPA2, QPB1, QPB2 thereof) in direction 399A (or generally in direction 399).

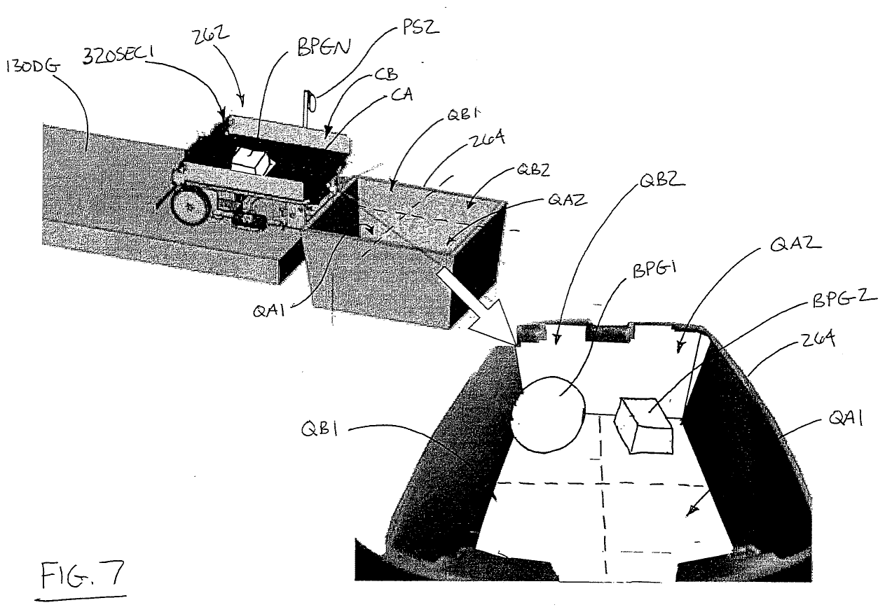

Referring to FIG. 3G, the operation of the drive motors 320C1-320C7 to rotate the drive shafts 320DS1-320DS7 also causes the protrusions 377H1-377H7 to sequentially engage and disengage the breakpack goods (in the example illustrated, breakpack goods BPGS but engagement and disengagement of the breakpack goods BPGL and breakpack goods BPG in general is the same) to push the breakpack goods in direction 399A (or generally in direction 399) for egress from the payload bed 310 into a breakpack goods container 264. As the breakpack goods BPG is moved in direction 399A, the predetermined ones of the drive shafts 320DS1-320DS7 are rotated so that the respective lateral conveyor section 320EC1-320SEC3 (in the example in FIG. 3G, lateral conveyor section 320SEC3) is dynamically formed by the protrusions 377H1-377H7 to effectively move the respective lateral conveyor section 320EC1-320SEC3 with the breakpack goods BPG. For example, the predetermined one or more of the drive shafts 300DS1-300DS7 are rotated so that protrusion 377H7 pushes breakpack good BPGS in direction 399A, where discrete lateral conveyor section 320SEC3 is defined in part by the protrusions 377H4, 377H7. As the breakpack good BPGS moves in direction 399A and disengages from protrusion 377H7, the protrusion 377H6 engages the breakpack good BPGS and continues to push breakpack goods in direction 399A, where the where holding section 320SEC3 is now defined in part by the protrusions 377H3, 377H6. The breakpack good BPGS continues to get pushed in direction 399A by the protrusions 377H (and the discrete payload holding section continues to be dynamically formed so as to move in direction 399A) in this manner until the breakpack goods is located adjacent open side 262PS of the payload bed 310 (see the bottom of FIG. 3G and FIG. 3E) or pushed from the payload bed 310 into a goods container 264 (e.g., in the same manner illustrated in FIG. 2C, see also FIGS. 5A-5D, and 7).

As illustrated in at least FIGS. 3A, 3B, and 3E both of the lateral conveyor sections 320SEC2, 320SEC3 are disposed on an opposite side of the support surface 320 (relative to the rollers 320R1, 320R2) than the lateral conveyor section 320SEC1 with the support surface 320 positioned in a predetermined breakpack transfer position so that either the lateral conveyor section 320SEC1 or the lateral conveyor sections 320SEC2, 320SEC3 are selectively presented in the payload bed 310 for receiving breakpack goods BPG. For example, FIGS. 3A and 3D illustrate the support surface 320 in a predetermined breakpack transfer position for transporting larger breakpack goods BPGL, while FIGS. 3B and 3C illustrate the support surface in another predetermined breakpack transfer position for transporting smaller breakpack goods BPGS.

With the support surface 320 positioned in each of the breakpack transfer positions (see FIGS. 3A-3D and 3E) a protrusion 377H is positioned adjacent end 262F1 of the goods bot 262 while another protrusion 377H is positioned adjacent end 262F2 so as to form a movable wall of the payload bed 310 and prevent undesired egress of breakpack goods BPG out of the payload bed 310 through open side 262PS of the payload bed 310. For example, with the support surface 320 positioned so that lateral conveyor section 320SEC1 is presented in the payload bed 310 for receiving breakpack goods BPG, the protrusion 377H2 is positioned adjacent the end 262F2 to block the open side 262PS while protrusion 377H1 is positioned adjacent the end 262F1. The protrusion 377H1 may form a pusher that pushes a breakpack good BPG slipping on the support surface 320 from the payload bed 310 through the opening 262PS with movement of the support surface in direction CD1 under impetus of the conveyor drive 300C. With the support surface 320 positioned so that the lateral conveyor sections 320SEC2, 320SEC3 are presented in the payload bed 310 for receiving breakpack goods BPG, the protrusion 377H3 is positioned adjacent end 262F1 of the goods bot 262, protrusion 377H4 is disposed about mid-way along the length PBL of the support surface 320B, and the protrusion 377H5 is positioned adjacent end 262F2. The protrusion 377H5 prevents undesired egress of breakpack goods BPG out of the payload bed 310 through open side 262PS of the payload bed 310. The protrusions 377H3, 377H4 may each form a pusher that pushes a breakpack good BPG slipping on the support surface 320 within a respective lateral conveyor section 320SEC2, 320SEC3 from the payload bed 310 through the opening 262PS with movement of the support surface in direction CD1 under impetus of the conveyor drive 300C. Positioning the support surface 320 in the different breakpack transfer positions may be effected in any suitable manner such as with a vision system (e.g., one or more of sensors PS1, PS2 and any suitable controller such as controller 262C) that detects at least the protrusions 377H or with any suitable sensors/encoders of the conveyor drive 300C.

While the payload bed 310 is illustrated as having one open side 262PS at or adjacent end 262F2 (which open side is at least partially blocked by a protrusion 377H so as to prevent breakpack goods egress), the payload bed may have (another) open side (or an opening—where such opening is formed between wall 310W2 and the conveyor 320B) at or adjacent end 262F1 where the other open side (or opening) is at least partially blocked by another protrusion 377H. The controller 262C may control the conveyor drive 300C (based on feedback from any suitable motor encoders, belt position sensors, vision systems, etc. of the goods bot 262) so that with the conveyor 310B in a predetermined breakpack transport position (as described herein—see FIGS. 3A-3D) a protrusion 377H is positioned at or adjacent the end 262F2 to at least partially block the open side 262PS and another protrusion 377H is positioned at or adjacent the end 262F1. For transferring breakpack goods BPG from the payload bed 310, the controller 262C commands the conveyor drive 300C to move the conveyor 320B so that the protrusion 377H (e.g., at or adjacent the side 262F2) is moved away from the open side 262PS in direction CD1, while the other protrusion(s) 377H is/are moved towards the open side 262PS to push any breakpack goods BPG (e.g., that may be slipping on the conveyor 320B) held on a conveyor section CA, CB and/or within a respective lateral conveyor section 320SEC1-320SEC3 out of the payload bed 310 through the open side 262PS.

The support surface 320, in the form of the endless belt conveyor 320B, may provide for a low-cost breakpack goods BPG transfer device with few moving parts (e.g., having a few parts as the rollers 320R1, 320R2, the drive conveyor drive 300C, and the belt conveyors 320B), where but (e.g., only) a single motor drives movement of the belt conveyor 320B for transferring breakpack goods BPG from the payload bed 310. The support surface 320, in the form of a roller conveyor 320CR may provide for dynamic formation of variably sized payload holding sections of the payload bed 310 for tailoring a seat size of the support surface to varying sizes of breakpack goods BPG.

The support surface 320 may be constructed of any suitable material (e.g., including but not limited to rubber, polyvinylchloride (PVC), polyester, rubber modified vinyl (RMV), etc.) having a suitable coefficient of friction to substantially prevent slippage of breakpack goods BPG on the support surface 320.

Referring again to FIGS. 2A, 2B, 3A, 3E, and 5A-5D, the payload bed 310 (and end effector 262E formed thereby) is movably coupled to the vehicle frame 262F by one or more linear slide 311 (or other suitable prismatic joint(s) that provide(s) linear (or telescoping) movement between the end effector 262 and vehicle frame 262F) so as to move in direction 399 between a retracted location/position (e.g., relative to the vehicle frame 262F as illustrated in FIGS. 2A and 5D) and an extended location/position (e.g., relative to the vehicle frame 262F as illustrated in FIGS. 2B and 5B). For example, referring also to FIG. 4, one or more rails 311A, 311B (generally referred to as rail 311) are coupled to the vehicle frame 262F to effect extension and retraction of the end effector 262E in direction 399, along the rails 311A, 311B as will be described herein. While two rails are illustrated in the figures, more or less than two rails may be provided. The rails 311A, 311B are positioned on the vehicle frame 262F to straddle the support surface 320, although the rails 311A, 311B may be disposed between the support surface 320 and the vehicle frame 262F. At least one slider 312 (two sliders 312A, 312B are at least partially illustrated in FIG. 4 for exemplary purposes) are stationarily coupled to the end effector frame 320EF and movably coupled to a respective one of the rails 311A, 311B so as to slide back and forth (e.g., reciprocate) along the respective rail 311A, 311B in direction 399.

The end effector 262E (and hence payload bed 310) is driven between the retracted position (as illustrated in, e.g., FIGS. 2A and 5D) and the extended (or partially extended) position (as illustrated in, e.g., FIGS. 2B and 5B) by an end effector drive 300E of the drive section 300. Referring to FIGS. 3A and 4 an exemplary end effector drive 300E is illustrated; however, the end effector drive 300E may have any suitable configuration (e.g., including one or more of piston drive(s) 300E1, ball-screw drive(s) 300E2, chain and sprocket drive(s) 300E3, belt and pulley drive(s) 300E4, magnetic actuators 300E5 and/or electric actuator(s) 300E6, etc.) for driving the end effector 262E in direction 399 between the retracted and extended positions. In the example illustrated in FIG. 4, the end effector drive 300E includes a rotary motor 370 that drives a pulley 371 (e.g., the pulley 371 is coupled to an output of the rotary motor 370 in any suitable manner). The pulley 371 in turn drives a serpentine belt 372 that is wrapped around multiple idler pulleys 373. The idler pulleys 373 provide for a belt transport path that includes two belt legs 372L1, 372L2 that travel in the same direction when the rotary motor 370 is actuated. For example, where the rotary motor 370 drives the pulley 371 in a counter-clockwise direction both belt legs 372L1, 372L2 move in extension direction 399A. Where the rotary motor 370 drives the pulley 372 in a clockwise direction both belt legs 372L1, 372L2 move in retraction direction 399B, e.g., where the serpentine belt 372 circulates in a substantially horizontal plane or plane parallel to a riding surface on which the goods bot 262 rides. The slider 312A is coupled (in any suitable manner such as a clamp 366) to the belt leg 372L1 and slider 312B is coupled (in any suitable manner such as a clamp) to the belt leg 372L2 so that both sliders (and the stanchions 313A, 313B coupled thereto) are moved simultaneously in one of directions 399A, 399B to extend or retract the end effector 262E. The end effector drive 300E may include any suitable belt tensioner 379 to maintain any suitable predetermined belt tension of the serpentine belt 372. The end effector drive 300E operated under of any suitable controller 262C (see FIG. 2A) of the goods bot 262 to effect transfer of breakpack goods BPG. In the example illustrated in FIG. 3A, the rotary motor 370 is arranged to drive one or more belts 372 (which may or may not be a serpentine belt) in circulation within a plane substantially perpendicular to the riding surface on which the goods bot 262 rides, where the one or more belts 372 are otherwise coupled to a respective slider 312A, 312B in a manner similar to that described with respect to FIG. 3B via a respective clamp 366.

Referring to FIGS. 2A, 2B, 3C and 3D the goods bot 262 effects, with at least the payload bed 310 (and end effector 262E formed thereby), controllable fill of the breakpack goods container 264 with the tote fill of breakpack goods BPG via a tote fill feedback device (such as at least one of sensors PS1, PS2) responsive to at least one of a fill level and arrangement of the tote fill. As an example, the end effector 262E/payload bed 310 may be bifurcated (e.g., with respect to breakpack goods BPG placement in the payload bay 310) along the longitudinal axis LAX (see FIG. 4B) of the goods bot 262 (i.e., along the direction of extension/retraction 399) so as to form the conveyor sections CA, CB. The bifurcation of the payload bed 310 corresponds to a similar bifurcation of the goods container 264 along the direction of extension and retraction 399 of the end effector 262E interfacing with the goods container 264. For example, the goods container 264 is also bifurcated in a direction transverse to the direction of extension and retraction 399 so that the goods container 264 is divided into quadrants QA1, QA2, QB1, QB2 where conveyor section CA (and discrete payload holding sections QPA1, QPA2 thereof) provides breakpack goods BPG to quadrants QA1, QA2 and conveyor section CB (and discrete payload holding sections QPB1, QPB2 thereof) provides breakpack goods to quadrants QB1, QB2. Configuring the goods bot 262, as described herein, to provide breakpack goods BPG to the different quadrants QA1, QA2, QB1, QB2 may effect the filling of the goods container 264 to the predetermined fill level 1222 (see FIGS. 5B and 5D).

As illustrated in FIGS. 5A and 5B, the payload bed 310 of the goods bot 262 is extended in direction 399 to effect deposition or placement (or otherwise a transfer) of breakpack goods BPG into quadrant QA2 and/or quadrant QB2 of the goods container 264. For example, to deposit or otherwise place/transfer breakpack goods BPG to quadrant QA2 one or more breakpack goods BPG are placed on conveyor section CA in accordance with the index 222 and the end effector 262E is extended from the retracted position (e.g., the retracted position being a rearward-most position, towards end 262F1, relative to the frame 262F as illustrated in FIG. 2A) in direction 399 towards the quadrant QA2 so that the end effector is in an extended position (e.g., the extended position being a forward-most position, towards end 262F2, relative to the frame 262F as illustrated in FIG. 2B). The endless belt conveyor 320B (or other suitable conveyance of the payload bed 310, such as the roller conveyor 320CR) is actuated to move the breakpack goods in direction 399 from the conveyor section CA into quadrant QA2, as mapped by the index 222, of the goods container 264. Similarly, to effect deposition or placement (or otherwise a transfer) of breakpack goods into quadrant QB2 of the goods container 264, one or more breakpack goods BPG are placed on conveyor section CB in accordance with the index 222 and the end effector 262E is extended in direction 399 towards the quadrant QB2. The endless belt conveyor 320B (or other suitable conveyance of the payload bed 310, such as the roller conveyor 320CR) is actuated to move the breakpack goods in direction 399 from the conveyor section CB into quadrant QB2, as mapped by the index 222, of the goods container 264.

As illustrated in FIGS. 5C and 5D, the payload bed 310 of the goods bot 262 is retracted in direction 399 (or is otherwise positioned in the retracted position) to effect deposition or placement (or otherwise a transfer) of breakpack goods BPG into quadrant QA1 and/or QB1 of the goods container 264. For example, to deposit or otherwise place/transfer breakpack goods BPG to quadrant QA1 one or more breakpack goods BPG are placed on conveyor section CA in accordance with the index 222 and the payload bed 310 is disposed in the retracted position. The endless belt conveyor 320B (or other suitable conveyance of the payload bed 310, such as the roller conveyor 320CR) is actuated to move the breakpack goods in direction 399 from the conveyor section CA into quadrant QA1, as mapped by the index 222, of the goods container 264. Similarly, to effect deposition of breakpack goods into quadrant QB1 of the goods container 264, one or more breakpack goods BPG are placed on conveyor section CB in accordance with the index 222 and the payload bed 310 is disposed in the retracted position. The endless belt conveyor 320B (or other suitable conveyance of the payload bed 310, such as the roller conveyor 320CR) is actuated to move the breakpack goods in direction 399 from the conveyor section CB into quadrant QB1, as mapped by the index 222, of the goods container 264.

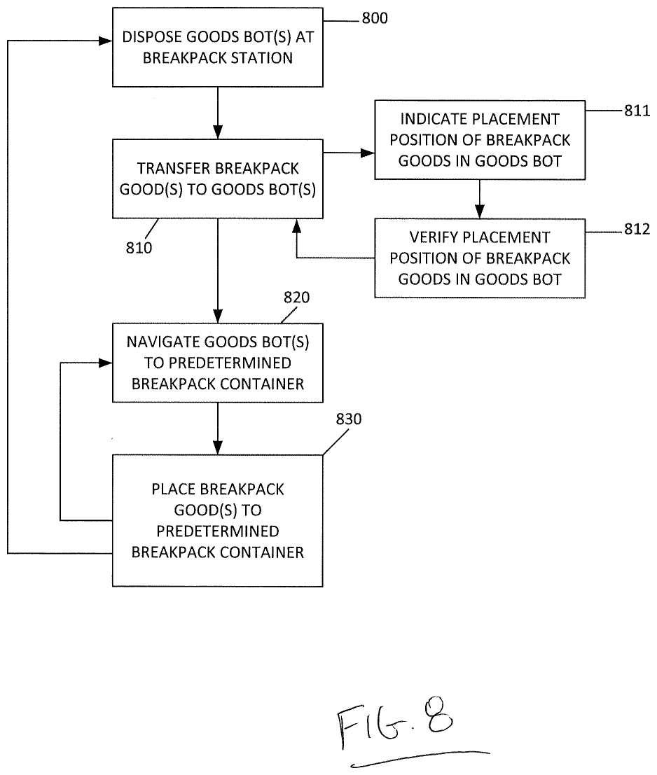

To effect transfer of breakpack goods BPG to a goods container 264, the goods bot 262 navigates along the goods transfer deck 130DG to a breakpack station 140 so that the goods bot 262 is disposed at a predetermined breakpack station 140 at which goods to be transferred by the goods bot are located (FIG. 8, Block 800). It is noted predetermined supply containers including the breakpack goods BPG to be picked are transferred to the breakpack station 140 in any suitable manner (such as described in United States provisional patent No. 63/452,749 filed on Mar. 17, 2023 and 63/452,758 filed Mar. 17, 2023 and U.S. patent application Ser. No. 17/358,383 filed Jun. 25, 2021, Ser. No. 17/657,705 filed Apr. 1, 2022, and Ser. No. 18/323,758 filed May 25, 2023, the disclosures of which were previously incorporated herein by reference in their entireties) where the supply container(s) are predetermined for transfer to the breakpack station 140 and the breakpack good(s) BPG are predetermined for picking by, for example, control server 120 and/or warehouse management system 2500 in accordance with order fulfillment.

At the breakpack station 140, the operator 140M picks the predetermined breakpack good(s) BPG from predetermined supply container(s) 265 and places the picked breakpack goods BPG onto the payload support 320 of a predetermined goods bot 262 (FIG. 8, Block 810). To effect placement of the breakpack goods BPG into the different quadrants QA1, QA2, QB1, QB2 of the breakpack goods container 264 the operator 140M is instructed in any suitable manner, such as by the index 222, to place picked breakpack good(s) BPG to a corresponding one or more of the conveyor sections CA, CB and/or to a corresponding discrete payload holding section QPA1, QPA2, QPB1, QPB2 (FIG. 8, block 811). For example, breakpack goods placement instruction may be provided by the goods bot 262 where the goods bot 262 includes one or more index 222 that may be selectively actuated to instruct or otherwise inform operator 140M placement of breakpack goods BPG into a predetermined conveyor section CA, CB and/or in one or more of the discrete payload holding sections QPA1, QPA2, QPB1, QPB2 (or otherwise within the payload bed 310).

The index 222 is connected to the payload bed 310. For example, each of the side walls 310W1, 310W3 (extending between the ends 262F1, 262F2) of the payload bay 310 includes, or otherwise has coupled thereto, the index 222, although the index may be connected to any suitable portion(s) of the payload bed 310. The index 222 has any suitable indexing indicia 222A-222D that indexes the discrete payload holding sections QPA1, QPA2, QPB1, QPB2 of the payload bed 310, and respectively maps the discrete payload holding sections QPA1, QPA2, QPB1, QPB2 to corresponding different place locations (such as one or more of the quadrants QA1, QA2, QB1, QB2) within a common breakpack goods container 264 or within different breakpack goods containers 264. The indexing indicia may be any suitable indicia including, but not limited to, a light source (e.g., light emitting diode, etc.) 222L, a movable flag 222F, etc. that serves to selectively identify (e.g., under control of controller 262C and in accordance with a predetermined breakpack goods container 264 fill) a breakpack goods place location within the payload bed 310.

Actuation of indexing indicia 222A, 222B (disposed on wall 310W1 adjacent conveyor section CB) instructs operator placement of breakpack good(s) BPG to conveyor section CB while actuation of visual indicators indexing indicia (disposed on wall 310W3 adjacent conveyor section CA) instructs operator placement of breakpack good(s) BPG to conveyor section CA. While the indexing indicia 222 are illustrated as being disposed on the walls 310W1, 310W3 the indexing indicia 222 may be disposed on any suitable portion of the goods bot 262 (or off-board the goods bot—such as at breakpack station 140—see FIG. 6B) so as to identify a respective conveyor section CA, CB.

For a substantially stochastic distribution of breakpack goods BPG in fill orders, loading the payload bed 310 with at least one breakpack good BPG (e.g., at the breakpack station 140) based on the index 222 effects or otherwise facilitates, via the placement effector 320EF, a substantially uniform fill of breakpack goods BPG to the predetermined fill level 1222 of a common breakpack goods container 264 or different breakpack goods containers 264.

As noted above, one or more of indexing indicia 222A, 222D may be actuated to indicate placement of breakpack goods BPG in discrete payload section QPA1, QPB1, (in a predetermined quadrant) and/or one or more of visual indicators 222B, 222C may be actuated to indicate placement of breakpack goods BPG in discrete payload section QPA2, QPB2 (in a predetermined quadrant), where discrete payload sections QPA1, QPA2, QPB1, QPB2 are presented in the payload bed 310 for accepting breakpack goods BPG. The index 222 indexes at least quadrant payload holding sections QPA1, QPA2, QPB1, QPB2 in the payload bed 310, although there may be more than four payload holding sections in the payload bed formed by any suitable number of discrete payload holding sections QPA1, QPA2, QPB1, QPB2 and/or any suitable number of virtual or physical partitions of the payload bed 310. The index 222 maps the at least quadrant payload holding sections QPA1, QPA2, QPB1, QPB2 to corresponding at least quadrant place locations QA1, QA2, QB1, QB2 in a common breakpack goods container 264 or at least quadrant place locations of different breakpack goods containers 264 of more than one breakpack goods container 264.

An exemplary mapping, with reference to FIG. 4B, for breakpack goods placement in a common breakpack goods container 264 may be where quadrant payload holding section QPA1 corresponds/maps to quadrant place location QA1, quadrant payload holding section QPA2 corresponds/maps to quadrant place location QA2, quadrant payload holding section QPB1 corresponds/maps to quadrant place location QB1, and quadrant payload holding section QPB2 corresponds/maps to quadrant place location QB2. The mapping may be dynamic depending on goods bot 262 loading and/or depending on whether the goods bot 262 extends the payload bed 310 to the extended position prior to placement of any breakpack goods BPG carried by the goods bot 262. For example, where one breakpack good BPG is carried on conveyor section CA any one of quadrant payload holding sections QPA1, QPA2 may be mapped to any one of quadrant place locations QA1, QA2. Where one breakpack good BPG is carried on conveyor section CB any one of quadrant payload holding sections QPB1, QPB2 may be mapped to any one of quadrant place locations QB1, QB2. Where a breakpack good BPG is carried in each of quadrant payload holding sections QPA1, QPA2, quadrant payload holding section QPA1 may be mapped to quadrant place location QA1 and quadrant payload holding section QPA2 may be mapped to quadrant place location QA2 where the payload bed 310 is in the extended position to place from quadrant payload holding section QPA2 or quadrant payload holding section QPA1 may be mapped to quadrant place location QA2 and quadrant payload holding section QPA2 may be mapped to quadrant place location QA1 where the payload bed 310 is in the retracted position to place from quadrant payload holding section QPA2. Where a breakpack good BPG is carried in each of quadrant payload holding sections QPB1, QPB2, quadrant payload holding section QPB1 may be mapped to quadrant place location QB1 and quadrant payload holding section QPB2 may be mapped to quadrant place location QB2 where the payload bed 310 is in the extended position to place from quadrant payload holding section QPB2 or quadrant payload holding section QPB1 may be mapped to quadrant place location QB2 and quadrant payload holding section QPB2 may be mapped to quadrant place location QB1 where the payload bed 310 is in the retracted position to place from quadrant payload holding section QPB2.

Where a breakpack good (such as breakpack good BPGM or breakpack good BPGL, see FIG. 5E) is sized such that the breakpack good BPGM does not fit within a single quadrant payload holding section QPA1, QPA2, QPB1, QPB2 more than one quadrant payload holding section QPA1, QPA2, QPB1, QPB2 may be commonly mapped to more than one quadrant place location QA1, QA2, QB1, QB2. For example, breakpack good BPGM is sized such that is occupies both quadrant payload holding sections QPA1, QPB1 such that quadrant payload holding sections QPA1, QPB1 are commonly mapped to payload place locations QA1, QB1 (see breakpack goods container 264E in FIG. 5E). As another example, breakpack good BPGL is sized such that is occupies quadrant payload holding sections QPA1, QPB1, QPA2, QPB2 such that quadrant payload holding sections QPA1, QPB1, QPA2, QPB2 are commonly mapped to payload place locations QA1, QB1, QA2, QB2 (see breakpack good container 264F in FIG. 5E.)

An exemplary mapping, with reference to FIG. 5E, for breakpack goods placement in a different breakpack goods containers 264B, 264C may be where quadrant payload holding section QPB2 of goods bot 262-2 is mapped to payload place location QB2 of breakpack goods container 264B and quadrant payload holding section QPA1 is mapped to payload place location QA1 of breakpack goods container 264C.

While the above exemplary mappings have been described, any suitable mapping between the quadrant (or greater than quadrant) payload holding sections and the quadrant (or greater than quadrant) place locations may be employed.

The payload bed 310 (e.g., the support surface 320) may be bifurcated along a longitudinal axis LAX of the goods bot 262 into the conveyor sections or sides CA, CB where one or more of the indexing indicia 222A-222D may be actuated to instruct operator placement of breakpack good(s) BPG into a predetermined discrete payload holding section QPA1, QPA2, QPB1, QPB2 on a predetermined conveyor side CA, CB in the manner described above. With the support surface 320 in the breakpack transfer position presenting conveyor sections 320SEC2, 320SEC3 in the payload bed 310 for receiving breakpack goods BPG, actuation of indexing indicia 222A instructs operator placement of breakpack good(s) to discrete payload holding section QPB1; actuation of indexing indicia 222B instructs operator placement of breakpack good(s) to discrete payload holding section QPB2; actuation of indexing indicia 222C instructs operator placement of breakpack good(s) to discrete payload holding section QPA2; and actuation of indexing indicia 222D instructs operator placement of breakpack good(s) to discrete payload holding section QPA1. With the support surface 320 in the breakpack transfer position presenting holding section 320SEC1 in the payload bed 310 for receiving breakpack goods BPG, actuation of one or more of indexing indicia 222A, 222B instructs operator placement of breakpack good(s) to discrete payload holding sections QPB1, QPB2, while actuation of one or more of indexing indicia 222C, 222D instructs operator placement of breakpack good(s) to discrete payload holding section QPA1, QPA2. Indicating breakpack goods placement on one or more of conveyor sides CA, CB provides for good bot placement of breakpack goods BPG into breakpack containers one a corresponding side of the breakpack container 264 (see FIGS. 5A and 5B). Actuation of one or more of indexing indicia 222A, 222D instructs operator placement of breakpack good(s) to discrete payload holding sections QPB1, QPA1, actuation of one or more of indexing indicia 222B, 222C instructs operator placement of breakpack good(s) to discrete payload holding sections QPB2, QPA2, and actuation of indexing indicia 222A-222D instructs operator placement of breakpack good(s) (such as breakpack good BPGL) to discrete payload holding sections QPB1, QPA1, QPB2, QPA2.

While the indexing indicia 222 are illustrated as being disposed on the walls 310W1, 310W3 the indexing indicia 222 may be disposed on any suitable portion of the goods bot 262 (or off-board the goods bot—such as at breakpack station 140—see FIG. 6B) so as to identify a respective conveyor section CA, CB.

The goods bot 262 may include any suitable sensor such as payload bed sensor PS2 configured for sensing proper placement of the breakpack goods BPG within the payload bed 310 (FIG. 8, Block 812). With placement of a breakpack good BPG within the payload bed 310, the controller 262C (or any other suitable controller in communication with the goods bot) determines the placement position of the breakpack good within the payload bed 310 based on sensor data received from the payload bed sensor PS2. With proper placement of the breakpack good BPG (e.g., to a predetermined one of the discrete payload holding sections QPA1, QPA2, QPB1, QPB2), the indexing indicia 222A-222D is deactivated and the goods bot proceeds to the predetermined breakpack goods container 264. Where more than one breakpack good BPG is to be transported another or the same indexing indicia 222A-222D may be illuminated instructing the operator to place another breakpack good into the payload bay 310. With improper placement of the breakpack good BPG, the indexing indicia 222A-222D may change appearance (e.g., change color, position, etc.) to indicate operator 140M assistance needed to rectify the improper placement. The goods bot 262 may remain at the operator station 140 until the placement of the breakpack goods BPG within the payload bed is rectified.

As illustrated in FIGS. 5A and 5B, the end effector 262E of the goods bot 262 may be extended in direction 399 to effect deposition or placement (or otherwise a transfer) of breakpack goods BPG into and to a distal side of a breakpack goods container 264 (relative to the goods bot 262 interfaced with the breakpack goods container 264). For example, to deposit or otherwise place/transfer breakpack goods BPG to the distal side of a breakpack goods container 264 the end effector 262E is extended from the retracted position (e.g., the retracted position being a rearward-most position, towards end 262F1, relative to the vehicle frame 262F as illustrated in FIG. 2A) in direction 399 towards so that the end effector is in an extended position (e.g., the extended position being a forward-most position, towards end 262F2, relative to the vehicle frame 262F as illustrated in FIG. 2B). The endless belt conveyor 320B (or other suitable conveyance of the end effector 262E) is actuated to move the breakpack goods in direction 399 from conveyor sections CA, CB (and/or from one or more of discrete payload holding sections QPA1, QPA2, QPB1, QPB2 of the support surface 320) to the distal side of the goods container 264.

As illustrated in FIGS. 5C, 5D, and 5E, the placement effector 320EF places one or more breakpack goods BPG, held in one or more corresponding discrete payload holding sections QPA1, QPA2, QPB1, QPB2, to a corresponding or different corresponding place location(s) QA1, QA2, QB1, QB2 of the common breakpack goods container 264 mapped by the index 222 with a common extension of the payload bed 310.

The placement effector 320EF places one or more breakpack goods BPG, held in one or more corresponding discrete payload holding sections QPA1, QPA2, QPB1, QPB2, to corresponding place location(s) QA1, QA2, QB1, QB2 of different breakpack goods containers 264 with or without extension of the payload bed 310.

The end effector 262E of the goods bot 262 is retracted in direction 399 or otherwise disposed in the retracted position to effect deposition or placement (or otherwise a transfer) of breakpack goods BPG into and to a proximate side of a breakpack goods container 264 (relative to the goods bot 262 interfaced with the breakpack goods container 264). For example, to deposit or otherwise place/transfer breakpack goods BPG to the proximate side of a breakpack goods container 264 in one or more of quadrants QA1, QB1 the end effector 262E is in the retracted position. The endless belt conveyor 320B (or other suitable conveyance of the end effector 262E/payload bed 310 such as the roller conveyor 320CR) is actuated to move the breakpack goods in direction 399 from one or more of conveyor sections CA, CB (and/or one or more of the discrete payload holding sections QPA1, QPA2, QPB1, QPB2 of the support surface 320) to a corresponding quadrant QA1, QB1 at the proximate side of the goods container 264.

The breakpack goods placement instruction (effected by the index 222) to a predetermined discrete payload holding section QPA1, QPA2, QPB1, QPB2 of the support surface 320 may be employed in combination with the distal/proximate breakpack goods placement effected by the extension/retraction of the end effector 262E transfer breakpack goods held in one or more of the discrete payload holding sections QPA1, QPA2, QPB1, QPB2 to a predetermined quadrant QA1, QA2, QB1, QB2 of the same or different breakpack goods containers 264.

With the breakpack good(s) BPG properly located within the payload bay 310, the goods bot 262 navigates along the goods deck 130DG to the predetermined breakpack goods container 264 and aligns the payload bay 310 with a predetermined goods container 264 (FIG. 8, Block 820) so that the longitudinal axis LAX of the goods bot 262 and the an axis BAX bifurcating the goods container 264 are substantially aligned with each other-see FIG. 4B). Navigation of the goods bot 262 along the goods transfer deck 130DG and alignment of the payload bed 310 of the goods bot 262 with the predetermined goods container 264 may be effected in any suitable manner such by the controller 262C based on data obtained from the at least one sensor PS1, PS2, such as in a manner similar to that described in U.S. provisional patent application No. 63/452,735 filed on Mar. 17, 2023 and U.S. patent application Ser. No. 17/657,705 filed Apr. 1, 2022, the disclosures of which were previously incorporated herein by reference in their entireties.

With the payload bed 310 aligned with the goods container 264, the goods bot 262 (such as with controller 262C) actuates the endless belt conveyor 320B or roller conveyor 320CR (e.g., actuates the conveyor drive 300C effecting movement of the endless belt conveyor 320B or roller conveyor 320CR in direction CD—see FIGS. 2A, 2C, 2D, 3A, and 3E) and/or extends the payload bed 310 (e.g., via actuation of the end effector drive 300E-see FIG. 2A) as described above for placement of breakpack goods BPG into one (or more) of the quadrants QA1, QA2, QB1, QB2 of the goods container 264 from one or more of the QPA1, QPA2, QPB1, QPB2 (FIG. 8, Block 830).

Where more than one breakpack goods BPG are placed in a common breakpack goods container 264 such placement may be effected with a common extension of the payload bed 310. For example, with reference to FIG. 5E, goods bot 262-1 aligns itself with breakpack goods container 264A at the interface 263. The payload bed 310 is extended and the placement effector 320EF places a breakpack good BPG from quadrant payload holding sections QPA2 to payload place location QA2 mapped by the index 222. The payload bed is retracted and the placement effector 320EF places a breakpack good BPG from quadrant payload holding sections QPB1 to quadrant place location QB1 mapped by the index 222. Breakpack goods BPG may be mapped and placed to any suitable quadrant place location of a common breakpack goods container 264 from any suitable quadrant payload holding sections of a goods bot 262.

At least one goods bot 262 may fill, with a common traverse, more than one different breakpack goods container 264 in the holding stations 263HS, by placing at least one breakpack good BPG, of a different discrete payload holding section QPA1, QPA2, QPB1, QPB2, in the corresponding place location QA1, QA2, QB1, QB2, of the more than one different breakpack goods container 264, mapped by the index 222. The index 222 maps the at least quadrant discrete payload holding sections QPA1, QPA2, QPB1, QPB2 to corresponding at least quadrant place locations QA1, QA2, QB1, QB2 in a breakpack goods container 264 of the more than one breakpack goods containers 264. As an example, more than one breakpack goods BPG are placed in different breakpack goods containers, such as breakpack goods containers 264B, 264C, by a common goods bot, such as goods bot 262-2, the goods bot 262-2 aligns itself with one breakpack goods container 264B. Breakpack good(s) BPG are placed into the breakpack goods container 264B with or without extension of the payload bed 310. In the example illustrated in FIG. 5E, the payload bed 310 is extended and the placement effector 320EF places a breakpack good from quadrant payload holding sections QPB2 to quadrant place location QB2. The goods bot 262 traverses to another breakpack goods container 264C and aligns itself with the other breakpack goods container 264C and the placement effector 320EF places a breakpack good from quadrant payload holding sections QPA1 to quadrant place location QA1. Breakpack goods BPG may be placed to any number of breakpack goods containers 264 any to any suitable quadrant place locations of the different breakpack goods containers 264 from any suitable quadrant payload holding sections of a common goods bot 262.

Where more than one goods bots, such as goods bots 262-3, 262-4 place breakpack goods to a common breakpack goods container 264, a first of the goods bots 262-3 traverses to the breakpack goods container, such as breakpack goods container 264D, and aligns itself with the breakpack goods container. The placement effector 320EF of the goods bot 262-3 places a breakpack good BPG to the breakpack goods container 264D in the manner described herein. In this example, the breakpack goods BPG is transferred from quadrant payload holding sections QPA2 of goods bot 262-3 to quadrant place location QA2 of the breakpack goods container 264D. The goods bot 262-3 traverses away from the breakpack goods container 264D and the other goods bot 262-4 traverses to and aligns itself with the breakpack goods container 264D. The placement effector 320EF of the goods bot 262-4 places a breakpack good BPG to the breakpack goods container 264D in the manner described herein. In this example, the breakpack goods BPG is transferred from quadrant payload holding sections QPB2 of goods bot 262-4 to quadrant place location QB2 of the breakpack goods container 264D. Breakpack goods BPG may be placed to any suitable quadrant place location of a common breakpack goods container 264 from any suitable quadrant payload holding sections of the more than one goods bot 262, noting that breakpack goods BPG placed in the common breakpack goods container 264 by one goods bots 262 may be placed in a same or different quadrant place location than breakpack goods BPG placed in the common breakpack goods container 264 by another of the goods bots 262 (i.e., breakpack goods may be placed stacked one on the other or placed adjacent one another).

Referring also to FIG. 7, the goods bot 264 includes sensor PS1 which is positioned on the goods bot for viewing at least an interior of the breakpack goods container 264 into which the goods bot 262 deposits the breakpack good(s) BPG. The sensor PS1 provides the controller 120 (or any other suitable controller 262C or warehouse management system 2500) sensor data that embodies the position of the breakpack goods BPG within the breakpack goods container 264, which sensor data may be employed to determine one or more of placement of a next breakpack goods BPG in the breakpack goods container 264 and a fill level of the breakpack goods container 264. The controller 120 instructing delivery of other breakpack goods BPG to the breakpack goods container 264 employs the sensor data so that the goods bots 262 delivering the other breakpack goods 264 provide visual indication(s) (similar to those described above) for breakpack goods BPG placement in the payload bay 210, and so that on delivery the breakpack goods container 264 is filled to the predetermined fill level 1222 (see FIGS. 5B and 5D).

The above-noted sensor data (e.g., feedback signal) obtained by the sensor PS1 with respect to the breakpack goods BPG within the goods container 264 may be referred to a goods container fill feedback that is communicated from the goods bot 262 to any suitable controller, such as controller 120. The controller 120 may determine (in any suitable manner, such as with any suitable vision analysis) whether a goods container 264 is filled (e.g., over a predetermined fill level 1222 such as about 80% filled or any other suitable amount that may be greater or less than 80% filled, see FIGS. 5B and 5D). Where the goods container 264 is not filled the controller 120 communicates with the breakpack module 266 (at which the goods container 264 is located) to command placement of additional breakpack goods BPG (if any additional breakpack goods BPG exist for the order to which the goods container belongs) into the goods container 264. In this manner, the goods container 264 fill is maximized and the number of goods containers for any given order are minimized.

As an example, breakpack goods BPG1, BPG2 are illustrated in FIG. 7 as being disposed (after placement by the goods bot 262) in quadrants QA2, QB2. To achieve the predetermined fill level 1222 (see FIGS. 5B and 5D), the controller 120 (e.g., based on one or more of the sensor data and characteristics (e.g., size, weight, etc.) of the next breakpack good to be placed in the breakpack goods container 264) determines a placement position of the next breakpack good BPG to be placed in the breakpack goods container 264. Based on the sensor data and characteristics of the next breakpack good BPGN is predetermined (e.g., by the controller 120) to be placed in quadrant QA1 of the breakpack goods container 264. To effect such placement, a goods bot 262 enters a predetermined (e.g., by the controller 120) breakpack operation station 140 at which the next breakpack good BPGN is located. The indexing indicia 222C, 222D corresponding to conveyor section CA are actuated to indicate, to the operator 140, placement of the next breakpack good BPGN to conveyor section CA. With placement of the next breakpack good BPGN to the conveyor section CA, the goods bot 262 traverses the goods deck 130DG and aligns itself (as noted above) with the breakpack goods container 264. With the payload bed 310 in the retracted position, the controller 262C actuates the conveyor drive 300C so that the next breakpack good BPGN is deposited into quadrant QA1 of the goods container 264. One or more of the goods bots 262 continues to fill the breakpack container in the manner described above according to an order, up to the predetermined fill level 1222.

Referring to at least FIGS. 2A and 2B, the goods bot 262 includes one or more payload bed sensors PS2 that are positioned on the goods bot 262 for imaging breakpack goods BPG held within the payload bed 310. One or more payload bed sensor(s) PS2 may be disposed above the payload bed 310 (e.g., such as on one or more stanchions SST, e.g., disposed at one or more of on a side of the payload bed 310, at a corner of the payload bed 310 or at any other suitable position on the vehicle frame 262F relative to the payload bed so as to image breakpack goods BPG held within the payload bed 310) so as to “look” down into the payload by 310, and/or one or more payload bed sensor(s) may be disposed adjacent a sensor window or aperture through one or more of the side walls 310W1-310W3 in a manner substantially similar to that described in U.S. provisional patent application No. 63/452,735 filed on Mar. 17, 2023, the disclosure of which was previously incorporated herein by reference in its entirety. The payload bed sensor(s) PS2 may be any suitable sensors such as stereo vision sensors, any suitable ranging sensors, and monocular sensors. The controller 262C (or any other suitable controller such as controller 120) includes any suitable imaging processing algorithms (including but not limited to neural networks) for processing data obtained by the one or more payload bed sensors PS2 for breakpack goods BPG detection.

The one or more sensors PS1, PS2 of the goods bot 262 may be used individually or any suitable combination to obtain one or more of the images of the breakpack goods (or lack thereof) in the payload bed 310 and/or breakpack goods container 264. The controller 262C (or any other suitable controller, such as controller 120) includes any suitable imaging processing algorithms, including but not limited to neural networks, that effects with the data from the sensor(s) PS1, PS2 detection of breakpack goods BPG within the payload bed 310 and/or breakpack goods container 264. The controller 262C may employ the one or more sensors PS1, PS2 to verify operator (manual or automated) placement of breakpack goods BPG within the payload bed 310 at a breakpack station 140 and/or to verify discharge of the breakpack goods BPG from the payload bed 310 to a breakpack goods container 264 at the interface 263.

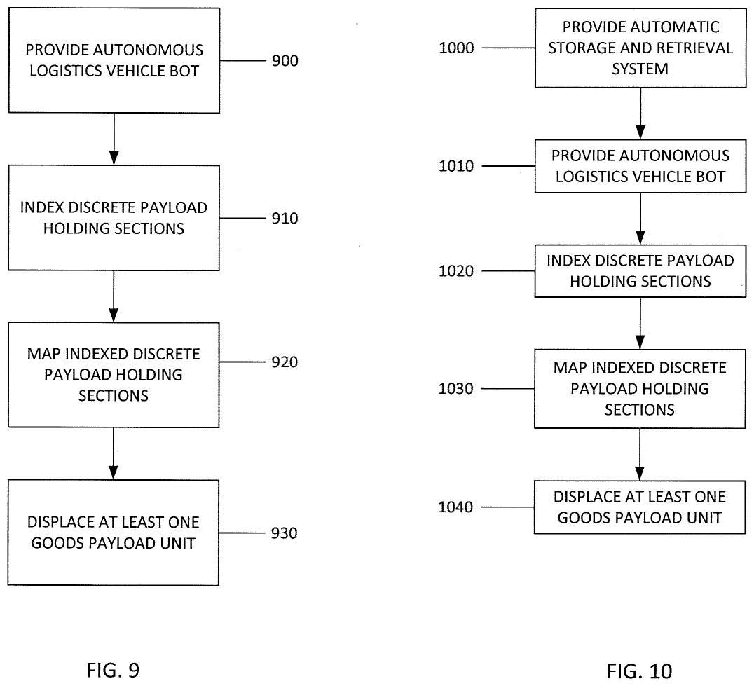

Referring to FIGS. 1-7 and 9, and exemplary method for transferring breakpack goods BPG will be described. A goods bot (also referred to as an autonomous logistics vehicle bot) 262 is provided (FIG. 9, Block 900). The goods bot 262 is as described herein and includes the vehicle frame 262F, the drive section 300, and the payload bed 310. The drive section 300 is operably connected to the vehicle frame 262F to autonomously move the goods bot 262 within a facility (such as the retail distribution center or warehouse). The payload bed 310 is disposed on the vehicle frame 262F and is arranged to stably hold breakpack goods BPG thereon, where the breakpack goods BPG are transported with the goods bot 262. The payload bed 310 is movably connected to the vehicle frame 262F so that the payload bed 310 moves between extended and retracted positions (see, for example, at least FIGS. 2A and 2B) relative to the vehicle frame 262F.

The index 222 of the payload bed 310 indexes the discrete payload holding sections QPA1, QPA2, QPB1, QPB2 (FIG. 9, Block 910) separate and distinct from each other. The index 222 maps each indexed discrete payload holding section QPA1, QPA2, QPB1, QPB2 to corresponding different place locations QA1, QA2, QB1, QB2 within a common breakpack goods container 264 (FIG. 9, Block 920), where each respective discrete payload holding section QPA1, QPA2, QPB1, QPB2 is configured to contain therein at least one breakpack goods BPG corresponding to the discrete payload holding section QPA1, QPA2, QPB1, QPB2. The placement effector 320EF of the payload bed 310, with the payload bed in the extended (or retracted) position, displaces the corresponding at least one breakpack goods BPG from each (or at least one) indexed respective payload holding section QPA1, QPA2, QPB1, QPB2, and places the corresponding at least one breakpack goods BPG in the corresponding place location QA1, QA2, QB1, QB2 mapped by the index 222 (FIG. 9, Block 930).

In accordance with the method illustrated in FIG. 9, the method may include one or more (in any suitable combination) of the following features (any one or more of which may be employed with the features described herein in any suitable combination): the index 222 is connected to the payload bed 310; the index 222 has indexing indicia 222A-222D that indexes the discrete payload holding sections QPA1, QPA2, QPB1, QPB2 of the payload bed 310, and respectively map to the corresponding different place locations QA1, QA2, QB1, QB2 within the common breakpack goods container 264; the payload bed 310 has a support surface 320, disposed to contact and support each of the breakpack goods BPG in the payload bed 310; the support surface 320 is arranged to traverse within the payload bed 310 and form the placement effector 320EF, the traverse of the support surface 320 displaces the at least one breakpack goods BPG corresponding to each discrete payload holding section QPA1, QPA2, QPB1, QPB2 and places the at least one breakpack goods BPG into the corresponding place location QA1, QA2, QB1, QB2 according to the index 222; the index 222 indexes at least quadrant payload holding sections QPA1, QPA2, QPB1, QPB2 in the payload bed 310; the index 222 maps the at least quadrant payload holding sections QPA1, QPA2, QPB1, QPB2 to corresponding at least quadrant place locations QA1, QA2, QB1, QB2 in the common breakpack goods container 264; the payload bed 310 has at least one sectioning wall, tab or protrusion 777 forming a demarking or boundary discriminating at least one of the discrete payload holding sections QPA1, QPA2, QPB1, QPB2 from another discrete payload holding section QPA1, QPA2, QPB1, QPB2 in accordance with the index 222; placing, with the placement effector 320EF, more than one of the at least one breakpack goods BPG, held in more than one corresponding discrete payload holding sections QPA1, QPA2, QPB1, QPB2, to more than one different corresponding place location QA1, QA2, QB1, QB2 of the common breakpack goods container 264 mapped by the index 222 with a common extension of the payload bed 310; loading the payload bed 310 with the at least one breakpack goods BPG based on the index 222, effects via the placement effector 320EF, substantially uniform fill of breakpack goods BPG to about 50% or more fill capacity of the common breakpack goods container 264; and filling, with the placement effector 320EF, more than one different breakpack goods container 264 by placing more than one of the at least one breakpack goods BPG, of a discrete payload holding section QPA1, QPA2, QPB1, QPB2, in a corresponding place location QA1, QA2, QB1, QB2, of the more than one different breakpack goods container 264, mapped by the index 222.

Referring to FIGS. 1-7 and 10, and exemplary method for transferring breakpack goods BPG will be described. An automatic storage and retrieval system 100 is provided (FIG. 10, Block 1000) in a facility. The automatic storage and retrieval system 100 has at least one goods bot 262 (also referred to as an autonomous logistics vehicle bot) configured to traverse a deck 130DG of the facility, and holding stations 263H that are arrayed within the facility and configured to hold more than one breakpack goods containers BPG so as to be filled with at least one breakpack goods BPG from the at least one goods bot 262.

A goods bot 262 is provided (FIG. 10, Block 1010). The goods bot 262 is as described herein and includes the vehicle frame 262F, the drive section 300, and the payload bed 310. The drive section 300 is operably connected to the vehicle frame 262F to autonomously move the goods bot 262 within a facility (such as the retail distribution center or warehouse). The payload bed 310 is disposed on the vehicle frame 262F and is arranged to stably hold breakpack goods BPG thereon, where the breakpack goods BPG are transported with the goods bot 262. The payload bed 310 is movably connected to the vehicle frame 262F so that the payload bed 310 moves between extended and retracted positions (see, for example, at least FIGS. 2A and 2B) relative to the vehicle frame 262F.

The index 222 of the payload bed 310 indexes the discrete payload holding sections QPA1, QPA2, QPB1, QPB2 (FIG. 10, Block 1020) separate and distinct from each other. The index 222 maps each indexed discrete payload holding section (FIG. 10, Block 1030) to corresponding different place locations QA1, QA2, QB1, QB2 common to and inside each of the more than one breakpack goods containers 264 at the holding stations 263H, where each respective discrete payload holding section QPA1, QPA2, QPB1, QPB2 is configured to contain therein the at least one breakpack goods BPG corresponding to the discrete payload holding section QPA1, QPA2, QPB1, QPB2. The placement effector 320EF of the payload bed 310 displaces, with the payload bed in the extended (or retracted) position, the corresponding at least one breakpack goods BPG, from at least one of the indexed respective discrete payload holding section QPA1, QPA2, QPB1, QPB2, and places the corresponding at least one breakpack goods BPG in the corresponding place location QA1, QA2, QB1, QB2 mapped by the index 222 (FIG. 10, Block 1040).

In accordance with the method illustrated in FIG. 10, the method may include one or more (in any suitable combination) of the following features (any one or more of which may be employed with the features described herein in any suitable combination): filling, with a common traverse of the at least one goods bot 262, more than one different breakpack goods container 264 in the holding stations 263H, by placing the at least one breakpack goods BPG, of a different discrete payload holding section QPA1, QPA2, QPB1, QPB2, in the corresponding place location QA1, QA2, QB1, QB2, of the more than one different breakpack goods container 264, mapped by the index 222; the index 222 is connected to the payload bed 310; the index 222 has indexing indicia 222A-222D that indexes the discrete payload holding sections QPA1, QPA2, QPB1, QPB2 of the payload bed 310, and respectively map to the corresponding different place locations QA1, QA2, QB1, QB2 common to and inside each of the more than one breakpack goods containers 264; the payload bed 310 has a support surface 320, disposed to contact and support each of the breakpack goods BPG in the payload bed 310; the support surface 320 is arranged to traverse within the payload bed 310 and form the placement effector 320EF, the traverse of the support surface 320 displaces the at least one breakpack goods BPG corresponding to each discrete payload holding section QPA1, QPA2, QPB1, QPB2 and places the at least one breakpack goods BPG into the corresponding place location QA1, QA2, QB1, QB2 according to the index 222; the index 222 indexes at least quadrant payload holding sections QPA1, QPA2, QPB1, QPB2 in the payload bed 310; the index 222 maps the at least quadrant payload holding sections QPA1, QPA2, QPB1, QPB2 to corresponding at least quadrant place locations QA1, QA2, QB1, QB2 in a breakpack goods container 264 of the more than one breakpack goods containers 264; the payload bed 310 has at least one sectioning wall, tab or protrusion 777 forming a demarking or boundary discriminating at least one of the discrete payload holding sections QPA1, QPA2, QPB1, QPB2 from another discrete payload holding section QPA1, QPA2, QPB1, QPB2 in accordance with the index 222; placing, with the placement effector 320EF, more than one of the at least one breakpack goods BPG, held in more than one corresponding discrete payload holding sections QPA1, QPA2, QPB1, QPB2, to more than one different corresponding place location QA1, QA2, QB1, QB2 of a common breakpack goods container 264, of the more than one breakpack goods containers 264, mapped by the index 222 with a common extension of the payload bed 310; loading the payload bed 310 with the at least one breakpack goods BPG based on the index 222, effects via the placement effector 320EF, substantially uniform fill of breakpack goods BPG to about 50% or more fill capacity of the common breakpack goods container 264; and placing, with the placement effector 320EF of more than one of the at least one goods bot 262, more than one of the at least one breakpack goods BPG, held in at least one corresponding discrete payload holding section QPA1, QPA2, QPB1, QPB2 of the more than one of the at least one goods bot 262, to corresponding place locations QA1, QA2, QB1, QB2 of a common breakpack goods container 264, of the more than one breakpack goods containers 264, mapped by the index 222 so that the more than one of the at least one goods bot 262 fills the common breakpack goods container 264.

The following features of the present disclosure are provided and may be employed individually, in any combination with each other, and/or in any combination with the features described above.

An autonomous logistics vehicle bot comprises: a vehicle frame; a drive section operably connected to the vehicle frame to autonomously move the autonomous logistics vehicle bot within a facility; and a payload bed disposed on the vehicle frame and arranged to stably hold goods payload units thereon transported with the autonomous logistics vehicle bot, the payload bed being movably connected to the vehicle frame so that the payload bed moves between extended and retracted positions relative to the vehicle frame; wherein the payload bed has an index that indexes discrete payload holding sections separate and distinct from each other, and maps each indexed discrete payload holding section to corresponding different place locations within a common tote;
wherein each respective discrete payload holding section is configured to contain therein at least one goods payload unit corresponding to the discrete payload holding section, and wherein the payload bed has a placement effector arranged so that with the payload bed in the extended position, the placement effector displaces the corresponding at least one goods payload unit, from each indexed respective discrete payload holding section, and places the corresponding at least one goods payload unit in the corresponding place location mapped by the index.

The index is connected to the payload bed.

The index has indexing indicia that indexes the discrete payload holding sections of the payload bed, and respectively map to the corresponding different place locations within the common tote.

The payload bed has a support surface, disposed to contact and support each of the goods payload units in the payload bed.

The support surface is arranged to traverse within the payload bed and form the placement effector, the traverse of the support surface displaces the at least one goods payload unit corresponding to each discrete payload holding section and places the at least one goods payload unit into the corresponding place location according to the index.

The index indexes at least quadrant payload holding sections in the payload bed.

The index maps the at least quadrant payload holding sections to corresponding at least quadrant place locations in the common tote.

The payload bed has at least one sectioning wall, tab or protrusion forming a demarking or boundary discriminating at least one of the discrete payload holding sections from another discrete payload holding section in accordance with the index.

The placement effector places more than one of the at least one goods payload unit, held in more than one corresponding discrete payload holding sections, to more than one different corresponding place location of the common tote mapped by the index with a common extension of the payload bed.

Loading the payload bed with the at least one goods payload unit based on the index, effects via the placement effector, substantially uniform fill of goods payload units to about 50% or more fill capacity of the common tote.

An automatic storage and retrieval system in a facility, the automatic storage and retrieval system comprises: at least one autonomous logistics vehicle bot configured to autonomously traverse a deck of the facility; and holding stations arrayed within the facility and configured to hold more than one totes so as to be filled with at least one goods payload unit from the at least one autonomous logistics vehicle bot; wherein the at least one autonomous logistics bot has: a vehicle frame; a drive section operably connected to the vehicle frame to autonomously move the at least one autonomous logistics vehicle bot within the facility; and a payload bed disposed on the vehicle frame and arranged to stably hold goods payload units thereon transported with the at least one autonomous logistics vehicle bot, the payload bed being movably connected to the vehicle frame so that the payload bed moves between extended and retracted positions relative to the vehicle frame; wherein the payload bed has an index that indexes discrete payload holding sections separate and distinct from each other, and maps each indexed discrete payload holding section to corresponding different place locations common to and inside each of the more than one totes at the holding stations; wherein each respective discrete payload holding section is configured to contain therein the at least one goods payload unit corresponding to the discrete payload holding section; and wherein the payload bed has a placement effector arranged so that with the payload bed in the extended position, the placement effector displaces the corresponding at least one goods payload unit, from at least one of the indexed respective discrete payload holding section, and places the corresponding at least one goods payload unit in the corresponding place location mapped by the index.

The at least one autonomous logistics vehicle bot fills, with a common traverse, more than one different tote in the holding stations, by placing the at least one goods payload unit, of a different discrete payload holding section, in the corresponding place location, of the more than one different tote, mapped by the index.

The index is connected to the payload bed.

The index has indexing indicia that indexes the discrete payload holding sections of the payload bed, and respectively map to the corresponding different place locations common to and inside each of the more than one totes.

The payload bed has a support surface, disposed to contact and support each of the goods payload units in the payload bed.

The support surface is arranged to traverse within the payload bed and form the placement effector, the traverse of the support surface displaces the at least one goods payload unit corresponding to each discrete payload holding section and places the at least one goods payload unit into the corresponding place location according to the index.

The index indexes at least quadrant payload holding sections in the payload bed.

The index maps the at least quadrant payload holding sections to corresponding at least quadrant place locations in a tote of the more than one totes.

The payload bed has at least one sectioning wall, tab or protrusion forming a demarking or boundary discriminating at least one of the discrete payload holding sections from another discrete payload holding section in accordance with the index.

The placement effector places more than one of the at least one goods payload unit, held in more than one corresponding discrete payload holding sections, to more than one different corresponding place location of the common tote mapped by the index with a common extension of the payload bed.

Loading the payload bed with the at least one goods payload unit based on the index, effects via the placement effector, substantially uniform fill of goods payload units to about 50% or more fill capacity of the common tote.

A method comprises: providing an autonomous logistics vehicle bot, the autonomous logistics vehicle bot having: a vehicle frame; a drive section operably connected to the vehicle frame to autonomously move the autonomous logistics vehicle bot within a facility; and a payload bed disposed on the vehicle frame and arranged to stably hold goods payload units thereon transported with the autonomous logistics vehicle bot, the payload bed being movably connected to the vehicle frame so that the payload bed moves between extended and retracted positions relative to the vehicle frame; indexing, with an index of the payload bed, discrete payload holding sections separate and distinct from each other; mapping, with the index, each indexed discrete payload holding section to corresponding different place locations within a common tote, where each respective discrete payload holding section is configured to contain therein at least one goods payload unit corresponding to the discrete payload holding section, and displacing, with a placement effector of the payload bed with the payload bed in the extended position, the corresponding at least one goods payload unit from each indexed respective payload holding section, and placing the corresponding at least one goods payload unit in the corresponding place location mapped by the index.

The index is connected to the payload bed.

The index has indexing indicia that indexes the discrete payload holding sections of the payload bed, and respectively map to the corresponding different place locations within the common tote.

The payload bed has a support surface, disposed to contact and support each of the goods payload units in the payload bed.

The support surface is arranged to traverse within the payload bed and form the placement effector, the traverse of the support surface displaces the at least one goods payload unit corresponding to each discrete payload holding section and places the at least one goods payload unit into the corresponding place location according to the index.

The index indexes at least quadrant payload holding sections in the payload bed.

The index maps the at least quadrant payload holding sections to corresponding at least quadrant place locations in the common tote.

The payload bed has at least one sectioning wall, tab or protrusion forming a demarking or boundary discriminating at least one of the discrete payload holding sections from another discrete payload holding section in accordance with the index.

Placing, with the placement effector, more than one of the at least one goods payload unit, held in more than one corresponding discrete payload holding sections, to more than one different corresponding place location of the common tote mapped by the index with a common extension of the payload bed.

Loading the payload bed with the at least one goods payload unit based on the index, effects via the placement effector, substantially uniform fill of goods payload units to about 50% or more fill capacity of the common tote.

Filling, with the placement effector, more than one different tote by placing more than one of the at least one goods payload unit, of a discrete payload holding section, in a corresponding place location, of the more than one different tote, mapped by the index.

A method comprises: providing an automatic storage and retrieval system in a facility, the automatic storage and retrieval system having: at least one autonomous logistics vehicle bot configured to autonomously traverse a deck of the facility; and holding stations arrayed within the facility and configured to hold more than one totes so as to be filled with at least one goods payload unit from the at least one autonomous logistics vehicle bot; providing the at least one autonomous logistics vehicle bot with: a vehicle frame; a drive section operably connected to the vehicle frame to autonomously move the at least one autonomous logistics vehicle bot within the facility; and a payload bed disposed on the vehicle frame and arranged to stably hold goods payload units thereon transported with the at least one autonomous logistics vehicle bot, the payload bed being movably connected to the vehicle frame so that the payload bed moves between extended and retracted positions relative to the vehicle frame; indexing, with an index of the payload bed, discrete payload holding sections separate and distinct from each other; mapping, with the index, each indexed discrete payload holding section to corresponding different place locations common to and inside each of the more than one totes at the holding stations, where each respective discrete payload holding section is configured to contain therein the at least one goods payload unit corresponding to the discrete payload holding section; and displacing, with a placement effector of the payload bed with the payload bed in the extended position, the corresponding at least one goods payload unit, from at least one of the indexed respective discrete payload holding section, and placing the corresponding at least one goods payload unit in the corresponding place location mapped by the index.

Filling, with a common traverse of the at least one autonomous logistics vehicle bot, more than one different tote in the holding stations, by placing the at least one goods payload unit, of a different discrete payload holding section, in the corresponding place location, of the more than one different tote, mapped by the index.

The index is connected to the payload bed.

The index has indexing indicia that indexes the discrete payload holding sections of the payload bed, and respectively map to the corresponding different place locations common to and inside each of the more than one totes.

The payload bed has a support surface, disposed to contact and support each of the goods payload units in the payload bed.

The support surface is arranged to traverse within the payload bed and form the placement effector, the traverse of the support surface displaces the at least one goods payload unit corresponding to each discrete payload holding section and places the at least one goods payload unit into the corresponding place location according to the index.

The index indexes at least quadrant payload holding sections in the payload bed.

The index maps the at least quadrant payload holding sections to corresponding at least quadrant place locations in a tote of the more than one totes.

The payload bed has at least one sectioning wall, tab or protrusion forming a demarking or boundary discriminating at least one of the discrete payload holding sections from another discrete payload holding section in accordance with the index.

Placing, with the placement effector, more than one of the at least one goods payload unit, held in more than one corresponding discrete payload holding sections, to more than one different corresponding place location of a common tote, of the more than one totes, mapped by the index with a common extension of the payload bed.

Loading the payload bed with the at least one goods payload unit based on the index, effects via the placement effector, substantially uniform fill of goods payload units to about 50% or more fill capacity of the common tote.

Placing, with the placement effector of more than one of the at least one autonomous logistics vehicle bot, more than one of the at least one goods payload unit, held in at least one corresponding discrete payload holding section of the more than one of the at least one autonomous logistics vehicle bot, to corresponding place locations of a common tote, of the more than one totes, mapped by the index so that the more than one of the at least one autonomous logistics vehicle bot fills the common tote.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the present disclosure.

What is claimed is:

1. An autonomous logistics vehicle bot comprising:
a vehicle frame;
a drive section operably connected to the vehicle frame to autonomously move the autonomous logistics vehicle bot within a facility; and
a payload bed disposed on the vehicle frame and arranged to stably hold goods payload units thereon transported with the autonomous logistics vehicle bot, the payload bed being movably connected to the vehicle frame so that the payload bed moves between extended and retracted positions relative to the vehicle frame;
wherein the payload bed has an index that indexes discrete payload holding sections separate and distinct from each other, and maps each indexed discrete payload holding section to corresponding different place locations within a common tote;
wherein each respective discrete payload holding section is configured to contain therein at least one goods payload unit corresponding to the discrete payload holding section, and
wherein the payload bed has a placement effector arranged so that with the payload bed in the extended position, the placement effector displaces the corresponding at least one goods payload unit, from each indexed respective discrete payload holding section, and places the corresponding at least one goods payload unit in the corresponding place location mapped by the index.

2. The autonomous logistics vehicle bot of claim 1, wherein the index is connected to the payload bed.

3. The autonomous logistics vehicle bot of claim 1, wherein the index has indexing indicia that indexes the discrete payload holding sections of the payload bed, and respectively map to the corresponding different place locations within the common tote.

4. The autonomous logistics vehicle bot of claim 1, wherein the payload bed has a support surface, disposed to contact and support each of the goods payload units in the payload bed.

5. The autonomous logistics vehicle bot of claim 4, wherein the support surface is arranged to traverse within the payload bed and form the placement effector, the traverse of the support surface displaces the at least one goods payload unit corresponding to each discrete payload holding section and places the at least one goods payload unit into the corresponding place location according to the index.

6. The autonomous logistics vehicle bot of claim 1, wherein the index indexes at least quadrant payload holding sections in the payload bed.

7. The autonomous logistics vehicle bot of claim 6, wherein the index maps the at least quadrant payload holding sections to corresponding at least quadrant place locations in the common tote.

8. The autonomous logistics vehicle bot of claim 1, wherein the payload bed has at least one sectioning wall, tab or protrusion forming a demarking or boundary discriminating at least one of the discrete payload holding sections from another discrete payload holding section in accordance with the index.

9. The autonomous logistics vehicle bot of claim 1, wherein the placement effector places more than one of the at least one goods payload unit, held in more than one corresponding discrete payload holding sections, to more than one different corresponding place location of the common tote mapped by the index with a common extension of the payload bed.

10. The autonomous logistics vehicle bot of claim 1, wherein loading the payload bed with the at least one goods payload unit based on the index, effects via the placement effector, substantially uniform fill of goods payload units to about 50% or more fill capacity of the common tote.

11. An automatic storage and retrieval system in a facility, the automatic storage and retrieval system comprising:
at least one autonomous logistics vehicle bot configured to autonomously traverse a deck of the facility; and
holding stations arrayed within the facility and configured to hold more than one totes so as to be filled with at least one goods payload unit from the at least one autonomous logistics vehicle bot;
wherein the at least one autonomous logistics bot has:
a vehicle frame;
a drive section operably connected to the vehicle frame to autonomously move the at least one autonomous logistics vehicle bot within the facility; and
a payload bed disposed on the vehicle frame and arranged to stably hold goods payload units thereon transported with the at least one autonomous logistics vehicle bot, the payload bed being movably connected to the vehicle frame so that the payload bed moves between extended and retracted positions relative to the vehicle frame;
wherein the payload bed has an index that indexes discrete payload holding sections separate and distinct from each other, and maps each indexed discrete payload holding section to corresponding different place locations common to and inside each of the more than one totes at the holding stations;
wherein each respective discrete payload holding section is configured to contain therein the at least one goods payload unit corresponding to the discrete payload holding section; and
wherein the payload bed has a placement effector arranged so that with the payload bed in the extended position, the placement effector displaces the corresponding at least one goods payload unit, from at least one of the indexed respective discrete payload holding section, and places the corresponding at least one goods payload unit in the corresponding place location mapped by the index.

12. The automatic storage and retrieval system of claim 11, wherein the at least one autonomous logistics vehicle bot fills, with a common traverse, more than one different tote in the holding stations, by placing the at least one goods payload unit, of a different discrete payload holding section, in the corresponding place location, of the more than one different tote, mapped by the index.

13. The automatic storage and retrieval system of claim 11, wherein the index is connected to the payload bed.

14. The automatic storage and retrieval system of claim 11, wherein the index has indexing indicia that indexes the discrete payload holding sections of the payload bed, and respectively map to the corresponding different place locations common to and inside each of the more than one totes.

15. The automatic storage and retrieval system of claim 11, wherein the payload bed has a support surface, disposed to contact and support each of the goods payload units in the payload bed.

16. The automatic storage and retrieval system of claim 15, wherein the support surface is arranged to traverse within the payload bed and form the placement effector, the traverse of the support surface displaces the at least one goods payload unit corresponding to each discrete payload holding section and places the at least one goods payload unit into the corresponding place location according to the index.

17. The automatic storage and retrieval system of claim 11, wherein the index indexes at least quadrant payload holding sections in the payload bed.

18. The automatic storage and retrieval system of claim 17, wherein the index maps the at least quadrant payload holding sections to corresponding at least quadrant place locations in a tote of the more than one totes.

19. The automatic storage and retrieval system of claim 11, wherein the payload bed has at least one sectioning wall, tab or protrusion forming a demarking or boundary discriminating at least one of the discrete payload holding sections from another discrete payload holding section in accordance with the index.

20. The automatic storage and retrieval system of claim 11, wherein the placement effector places more than one of the at least one goods payload unit, held in more than one corresponding discrete payload holding sections, to more than one different corresponding place location of the common tote mapped by the index with a common extension of the payload bed.

21. The automatic storage and retrieval system of claim 11, wherein loading the payload bed with the at least one goods payload unit based on the index, effects via the placement effector, substantially uniform fill of goods payload units to about 50% or more fill capacity of the common tote.

22. A method comprising:
providing an autonomous logistics vehicle bot, the autonomous logistics vehicle bot having:
a vehicle frame;
a drive section operably connected to the vehicle frame to autonomously move the autonomous logistics vehicle bot within a facility; and
a payload bed disposed on the vehicle frame and arranged to stably hold goods payload units thereon transported with the autonomous logistics vehicle bot, the payload bed being movably connected to the vehicle frame so that the payload bed moves between extended and retracted positions relative to the vehicle frame;
indexing, with an index of the payload bed, discrete payload holding sections separate and distinct from each other;
mapping, with the index, each indexed discrete payload holding section to corresponding different place locations within a common tote, where each respective discrete payload holding section is configured to contain therein at least one goods payload unit corresponding to the discrete payload holding section, and
displacing, with a placement effector of the payload bed with the payload bed in the extended position, the corresponding at least one goods payload unit from each indexed respective payload holding section, and placing the corresponding at least one goods payload unit in the corresponding place location mapped by the index.

23. The method of claim 22, wherein the index is connected to the payload bed.

24. The method of claim 22, wherein the index has indexing indicia that indexes the discrete payload holding sections of the payload bed, and respectively map to the corresponding different place locations within the common tote.

25. The method of claim 22, wherein the payload bed has a support surface, disposed to contact and support each of the goods payload units in the payload bed.

26. The method of claim 25, wherein the support surface is arranged to traverse within the payload bed and form the placement effector, the traverse of the support surface displaces the at least one goods payload unit corresponding to each discrete payload holding section and places the at least one goods payload unit into the corresponding place location according to the index.

27. The method of claim 22, wherein the index indexes at least quadrant payload holding sections in the payload bed.

28. The method of claim 27, wherein the index maps the at least quadrant payload holding sections to corresponding at least quadrant place locations in the common tote.

29. The method of claim 22, wherein the payload bed has at least one sectioning wall, tab or protrusion forming a demarking or boundary discriminating at least one of the discrete payload holding sections from another discrete payload holding section in accordance with the index.

30. The method of claim 22, further comprising placing, with the placement effector, more than one of the at least one goods payload unit, held in more than one corresponding discrete payload holding sections, to more than one different corresponding place location of the common tote mapped by the index with a common extension of the payload bed.

31. The method of claim 22, wherein loading the payload bed with the at least one goods payload unit based on the index, effects via the placement effector, substantially uniform fill of goods payload units to about 50% or more fill capacity of the common tote.

32. The method of claim 22, further comprising filling, with the placement effector, more than one different tote by placing more than one of the at least one goods payload unit, of a discrete payload holding section, in a corresponding place location, of the more than one different tote, mapped by the index.

33. A method comprising:
providing an automatic storage and retrieval system in a facility, the automatic storage and retrieval system having:
at least one autonomous logistics vehicle bot configured to autonomously traverse a deck of the facility; and
holding stations arrayed within the facility and configured to hold more than one totes so as to be filled with at least one goods payload unit from the at least one autonomous logistics vehicle bot;
providing the at least one autonomous logistics vehicle bot with:
a vehicle frame;
a drive section operably connected to the vehicle frame to autonomously move the at least one autonomous logistics vehicle bot within the facility; and
a payload bed disposed on the vehicle frame and arranged to stably hold goods payload units thereon transported with the at least one autonomous logistics vehicle bot, the payload bed being movably connected to the vehicle frame so that the payload bed moves between extended and retracted positions relative to the vehicle frame;
indexing, with an index of the payload bed, discrete payload holding sections separate and distinct from each other;
mapping, with the index, each indexed discrete payload holding section to corresponding different place locations common to and inside each of the more than one totes at the holding stations, where each respective discrete payload holding section is configured to contain therein the at least one goods payload unit corresponding to the discrete payload holding section; and
displacing, with a placement effector of the payload bed with the payload bed in the extended position, the corresponding at least one goods payload unit, from at least one of the indexed respective discrete payload holding section, and placing the corresponding at least one goods payload unit in the corresponding place location mapped by the index.

34. The method of claim 33, further comprising filling, with a common traverse of the at least one autonomous logistics vehicle bot, more than one different tote in the holding stations, by placing the at least one goods payload unit, of a different discrete payload holding section, in the corresponding place location, of the more than one different tote, mapped by the index.

35. The method of claim 33, wherein the index is connected to the payload bed.

36. The method of claim 33, wherein the index has indexing indicia that indexes the discrete payload holding sections of the payload bed, and respectively map to the corresponding different place locations common to and inside each of the more than one totes.

37. The method of claim 33, wherein the payload bed has a support surface, disposed to contact and support each of the goods payload units in the payload bed.

38. The method of claim 37, wherein the support surface is arranged to traverse within the payload bed and form the placement effector, the traverse of the support surface displaces the at least one goods payload unit corresponding to each discrete payload holding section and places the at least one goods payload unit into the corresponding place location according to the index.

39. The method of claim 33, wherein the index indexes at least quadrant payload holding sections in the payload bed.

40. The method of claim 39, wherein the index maps the at least quadrant payload holding sections to corresponding at least quadrant place locations in a tote of the more than one totes.

41. The method of claim 33, wherein the payload bed has at least one sectioning wall, tab or protrusion forming a demarking or boundary discriminating at least one of the discrete payload holding sections from another discrete payload holding section in accordance with the index.

42. The method of claim 33, further comprising placing, with the placement effector, more than one of the at least one goods payload unit, held in more than one corresponding discrete payload holding sections, to more than one different corresponding place location of a common tote, of the more than one totes, mapped by the index with a common extension of the payload bed.

43. The method of claim 33, wherein loading the payload bed with the at least one goods payload unit based on the index, effects via the placement effector, substantially uniform fill of goods payload units to about 50% or more fill capacity of the common tote.

44. The method of claim 33, further comprising placing, with the placement effector of more than one of the at least one autonomous logistics vehicle bot, more than one of the at least one goods payload unit, held in at least one corresponding discrete payload holding section of the more than one of the at least one autonomous logistics vehicle bot, to corresponding place locations of a common tote, of the more than one totes, mapped by the index so that the more than one of the at least one autonomous logistics vehicle bot fills the common tote.
